(19) United States
(12) Patent Application Publication
(10) Pub. No.: US 2026/0063025 A1
(43) Pub. Date: Mar. 5, 2026

(54) AI APPROACH FOR DRILLING OPERATION INSIGHTS

(71) Applicant: Schlumberger Technology Corporation, Sugar Land, TX (US)

(72) Inventors: Ming Xiang Lee, Kuala Lumpur (MY); Ziyu Wang, Beijing (CN)

(21) Appl. No.: 19/298,782

(22) Filed: Aug. 13, 2025

Related U.S. Application Data
(60) Provisional application No. 63/687,908, filed on Aug. 28, 2024.

(51) Int. Cl. E21B 44/00

(52) U.S. Cl. CPC E21B 44/00; E21B 2200/20; E21B 2200/22

(57) ABSTRACT

A method for monitoring a drilling operation includes receiving input data and additional supporting documents. The method also includes building a drilling-related retrieval augmented generation (RAG) knowledge database based upon the input data and the additional supporting documents. The method also includes filling knowledge gaps of an artificial intelligence (AI) large language model (LLM) based upon the drilling-related RAG knowledge database to produce an updated AI LLM. The method also includes receiving instructions to perform a task that is related to the drilling operation. The method also includes generating a result in response to the instructions using the updated AI LLM.

### CROSS-REFERENCE TO RELATED APPLICATIONS

This application claims priority to U.S. Provisional Patent Application No. 63/687,908, filed on Aug. 28, 2024, which is incorporated by reference.

### BACKGROUND

Many documents may exist with insights that are helpful in analyzing the operational trends of new wells. This information may be buried in well reports of various formats. For example, a drilling engineer may read a daily drilling report (DDR) manually to extract the operation remarks and identify the drilling risks that were not captured in a non-productive time (NPT) report. The manual effort is time-consuming, labor-intensive, and non-scalable.

Automation with natural language processing (NLP) techniques may help to extract the operation remarks and identify the drilling risks. However, this involves data labelling for supervised learning. In addition, the existing language models are not powerful enough to process the different document formats. Moreover, the existing language models are not domain-specific for oil and gas industry. Therefore, what is needed is an artificial intelligence (AI) approach for generating drilling operation insights.

### SUMMARY

A method for monitoring a drilling operation is disclosed. The method includes receiving input data and additional supporting documents. The method also includes building a drilling-related retrieval augmented generation (RAG) knowledge database based upon the input data and the additional supporting documents. The method also includes filling knowledge gaps of an artificial intelligence (AI) large language model (LLM) based upon the drilling-related RAG knowledge database to produce an updated AI LLM. The method also includes receiving instructions to perform a task that is related to the drilling operation. The method also includes generating a result in response to the instructions using the updated AI LLM.

In another embodiment, the method includes receiving input data. The input data is received from a web application. The input data includes multi-format documents including hypertext markup language (HTML), images, scanned documents, portable document format (PDF), character separated values (CSV) format, table format, or a combination thereof. The input data includes one or more daily drilling reports (DDRs). The one or more DDRs include unstructured data. The one or more DDRs are received from different vendors and/or different drilling operators. The method also includes parsing the input data to produce parsed data. The input data is parsed based upon a content type of the input data including object character recognition (OCR), table extraction, data cleaning, or a combination thereof. The parsed data includes structured results in a comma-separated values (CSV) format. The method also includes receiving additional supporting documents comprising a dictionary of technical abbreviations, professional term explanations, historical cases related to historical drilling operations, or a combination thereof. The input data and the additional supporting documents form a knowledge base that includes a plurality of knowledge fragments. The method also includes building a drilling-related retrieval augmented generation (RAG) knowledge database based upon the input data, the parsed data, and/or the additional supporting documents. Building the drilling-related RAG knowledge database implements a multi-granularity text segmentation strategy that improves a quality of the knowledge fragments. Building the drilling-related RAG knowledge database combines different chunk sizes and overlap parameters to adapt to a diversity of the input data and the additional supporting documents and to improve a retrieval accuracy and a generation quality. The chunk sizes and overlap parameters are (1000, 100), (512, 20), and/or (256, 20). Building the drilling-related RAG knowledge database implements knowledge vectorization based upon multiple embedding models to vectorize the knowledge fragments, which enhances a semantic expression ability and cross-model capability of the knowledge base. Building the drilling-related RAG knowledge database uses an AI similarity search and a vector database to balance retrieval efficiency and data management capabilities. The method also includes filling knowledge gaps of an artificial intelligence (AI) large language model (LLM) based upon the drilling-related RAG knowledge database to produce an updated AI LLM. The method also includes receiving instructions to perform a task. The instructions are received with a domain prompt template. The domain prompt template includes one or more fields including objective, step, example, explanation, and/or expected output. The task is related to the drilling operation. The method also includes generating a prompt based upon the drilling-related RAG knowledge database and the instructions. The method also includes generating a result in response to the prompt using the updated AI LLM. The result identifies drilling risks associated with the task. The method also includes displaying the result. The method also includes performing an action based upon or in response to the result.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a project solution architecture workflow, according to an embodiment.

FIG. 3 illustrates a prompt model workflow, according to an embodiment.

FIG. 4 illustrates a RAG model workflow, according to an embodiment.

FIG. 5 illustrates a LLM fine-tuning workflow, according to an embodiment.

FIG. 6 illustrates a schematic view of project deliverables, according to an embodiment.

FIG. 7 illustrates a part of the DDR, according to an embodiment.

FIG. 8 illustrates the distribution of the drilling risk samples, according to an embodiment.

FIG. 9 illustrates a schematic view of a LLM sequential customization workflow, according to an embodiment.

FIG. 10 illustrates extracted text provided as input, along with a crafted prompt, to the GPT-4 language model, according to an embodiment.

FIG. 11 illustrates an in-context learning process that shows how a language model makes decisions through ICL, according to an embodiment.

FIG. 12 illustrates a chain-of-thought idea for ICL, according to an embodiment.

FIG. 13 illustrates a prompt with the RAG model, according to an embodiment.

FIG. 14 illustrates a workflow to create a knowledge database, according to an embodiment.

FIG. 15 illustrates examples of the output produced by three different text splitters, according to an embodiment.

FIG. 16 illustrates the input set of labeled drilling event examples in the format of prompt-completion pair, with instruction prompt templates aligned with the LLM used for fine tuning, according to an embodiment.

FIG. 17 illustrates a schematic view of a PEFT workflow for DDR event identification, according to an embodiment.

FIG. 18 illustrates a graph showing precision and recall evaluation (e.g., weighted emphasize on major class, unweighted-treat the classes equally).

FIG. 19 statistics of a prediction distribution after a second engineering validation, according to an embodiment.

FIG. 20 illustrates a flowchart of a method for generating drilling operation insights, according to an embodiment.

FIG. 21 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

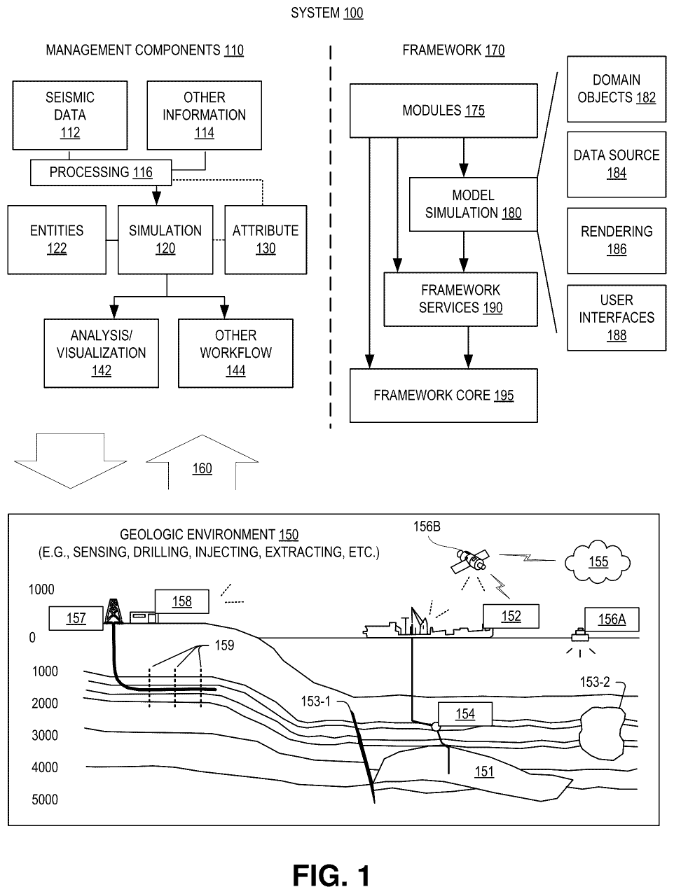

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### AI Approach for Drilling Operation Insights Using GenAI LLM

The present disclosure leverages generative artificial intelligence (AI) large language models (LLMs) to bridge the technical gap between domain engineers and artificial intelligence. More particularly, the present disclosure uses a web application with a generalized pipeline developed to overcome the limitation of the existing NLP model. This may allow users to generate better and more concise responses by incorporating the prompt design to enrich the context of the prompt sent to the LLM, which may reduce the risk of hallucinations.

The method also uses retrieval augmented generation (RAG) to overcome the knowledge cutoff concern from the pretrained foundation model. The method may then be extended to LLM fine-tuning with both cloud and on prem language model, to further enhance the risk identification model performance.

The method uses a pipeline of optical character recognition (OCR), 3 different modelling approaches to reduce the LLM risks of hallucinations, and knowledge cutoff, as well as post processing to enable user to get the structured outcome immediately. As a result, a user (e.g., engineer) may upload documents and change prompts according to a desired task to generate the structure results.

A prompt design component may enhance model context and allow engineers who do not know prompt engineering to follow step-by step guidance. The RAG workflow creates a domain knowledge base with efficient and cost-free embedding models. Local fine-tuned models and workflows provide better performance.

As a result, the method uses GenAI LLM to identify the drilling risk better than the conventional NLP model (e.g., transformer, GPT2 model, etc.). The 3 developed approaches are even outperforming the custom oil and gas fine tune GPT2 model.

The method uses step-by-step LLM customization starting from a foundation mode, a foundation with additional context (e.g., prompt and RAG), and customizing the dedicated weight layer of the foundation model for specific use case. The method may provide the following benefits:
1. Generalized pipeline to cater diverse report format
2. Better model performance with minimal explanation and example without data labelling
3. Scalability of current invention to other use cases and domains

### Workflow Description

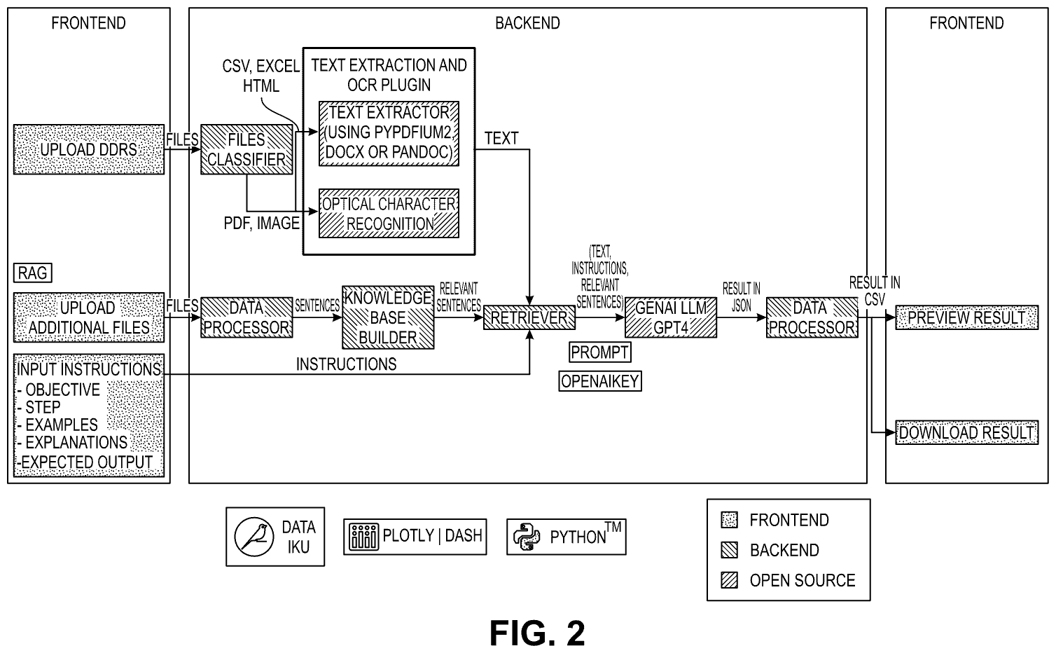

FIG. 2 illustrates a project solution architecture workflow, according to an embodiment. The workflow starts by receiving input unstructured data either in PDF, HTML, CSV, or Excel format. Users upload the DDR reports from the web application, together with the instructions to the LLM model to perform desired tasks. The documents may go through an OCR pipeline, and the results may be post-processed as structured results in CSV format. If the users would like to further enrich the context of the instructions sent to the LLM, they can select the RAG model and upload additional documents to build their own domain relevant database to enrich the knowledge during the LLM inference.

### Model Architecture

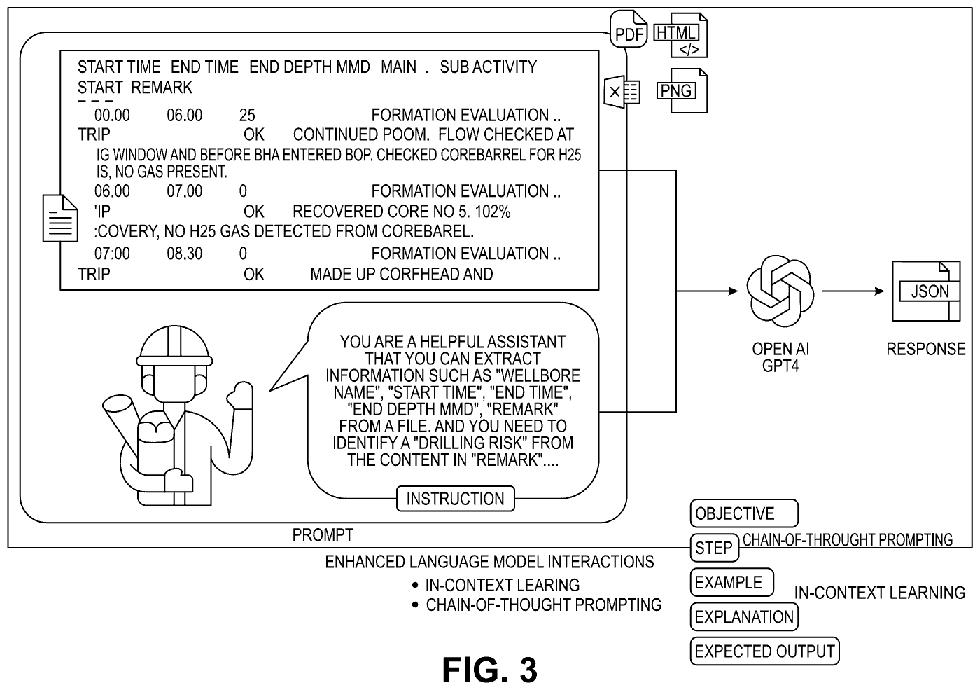

FIG. 3 illustrates a prompt model workflow, according to an embodiment. Five prompt components have been developed to enhance the user experience with language model and improve the model performance by giving a more concise and specific prompt instructions. This leverages the concept of in-context learning and chain-of-thought prompting as part of the prompt components.

Five components that may provide better prompt input to achieve a quality completion output are:
1. Role play with objective—setting objectives and specify the constraints
2. Steps—chain of thought concept, step by step instructions give close to 100% extraction accuracy
3. Examples—Optional input, good to have especially for prediction tasks.
4. Explanations—Optional input, explaining the additional context
5. Expected output headers—Output headers for CSV

### Retrieval Augmented Generation (RAG) Model

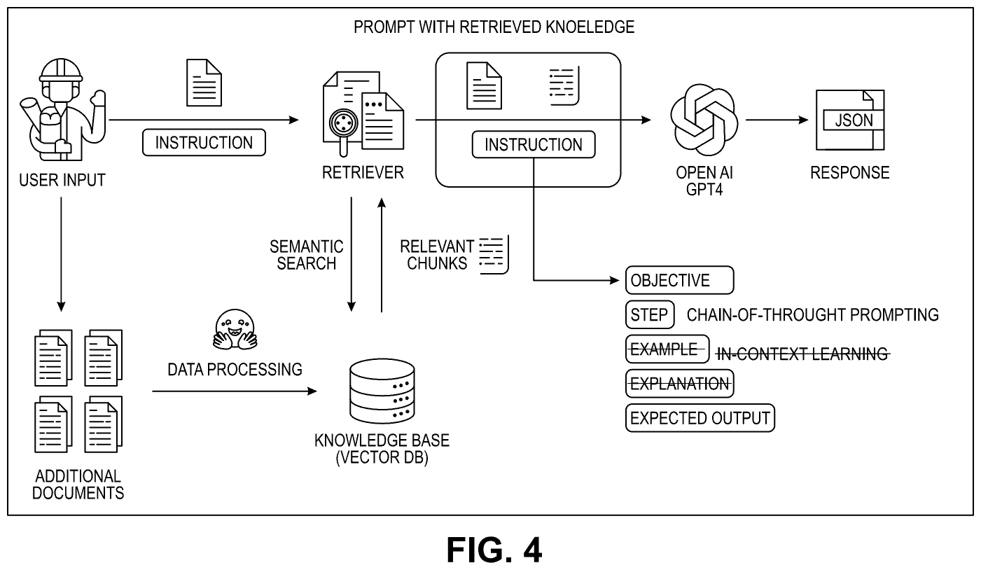

FIG. 4 illustrates a RAG model workflow, according to an embodiment. Instead of applying a RAG technique for summarization or cost efficiency to reduce input tokens to the LLM, the method applies this approach by combining a retrieval component with a text generator model to enrich the context of the input instructions to the LLM for better model performance.

Users may build their domain specific knowledge base by uploading additional domain relevant documents. During the data processing, by converting the documents to the embeddings into a vector database, a Hugging Face embedding model may outperform the Open AI embedding model. This offers users a cost-free, local processing, and self-hosting option to build their proprietary knowledge base.

### Fine Tune Model

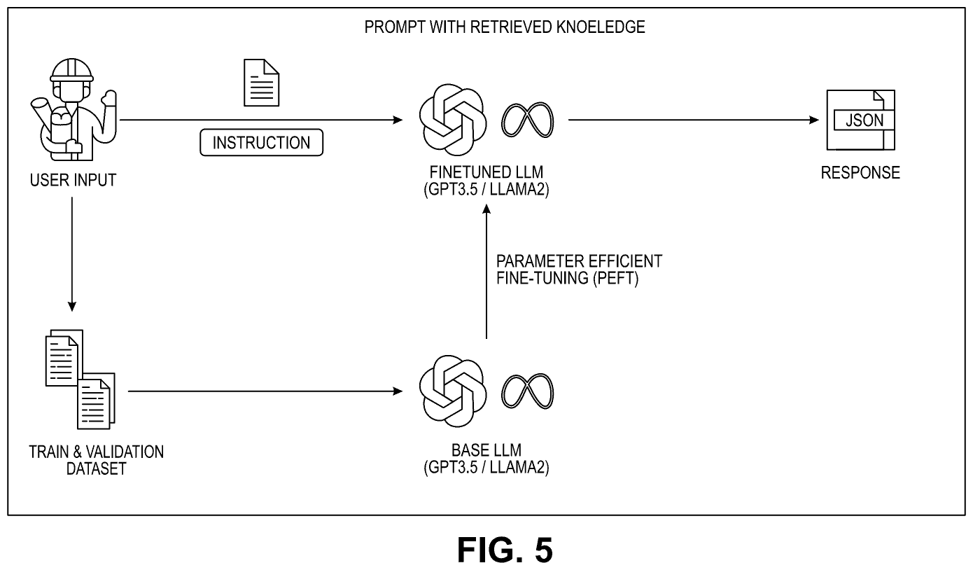

FIG. 5 illustrates a LLM fine-tuning workflow, according to an embodiment. A Parameter-Efficient-Fine-Tuning (PEFT) technique may be implemented to enable efficient adaptation of a large foundation pretrained model. This may fine tune a local LLM for a specific task. The fine-tuning results outperform the results from a prompt and RAG model. Hyperparameters and a post-processing similarity check algorithm may be used to further enhance the results. Special characters may be introduced for the expected output at the input prompt. A post processing algorithm may also be added to the fine-tuning pipeline to give better control to the result outcome.

### Results & Evaluation

The following results are validated with subsamples of 342 drilling risk remarks retrieved from 178 DDR. The labels were provided by a drilling engineer. Table 1 illustrates prompt model results comparison for zero shot, one shot without explanation, and one shot with explanations, according to an embodiment.

TABLE 1

| | | Precision | | Recall | |
|---|---|---|---|---|---|
| | | Unweighted* | Weighted* | Unweighted* | Weighted* |
| Description | Accuracy | (Equal) | (Major) | (Equal) | (Major) |
| Zero Shot No examples & explanations | 0.61 | 0.57 | 0.80 | 0.68 | 0.61 |
| One Shot 1 example for each category | 0.66 | 0.62 | 0.83 | 0.80 | 0.66 |
| No explanation | | | | | |
| One Shot 1 example for each category | 0.81 | 0.72 | 0.87 | 0.80 | 0.81 |
| Add explanation for each category | | | | | |

Different impacts of data processing for RAG modelling were analyzed. The chunk strategy, chunk size, input data, and embedding models were compared for better model inference performance. Table 2 illustrates RAG model results using different chinking strategies, according to an embodiment.

TABLE 2

| | | Precision | | Recall | |
|---|---|---|---|---|---|
| | | Unweighted* | Weighted* | Unweighted* | Weighted* |
| Description | Accuracy | (Equal) | (Major) | (Equal) | (Major) |
| Fixed-size chunking: Character | 0.75 | 0.60 | 0.88 | 0.83 | 0.75 |
| Text Splitter | | | | | |
| “Content-aware” chunking: Sentence | 0.73 | 0.59 | 0.88 | 0.80 | 0.73 |
| splitting using Natural Language | | | | | |
| Toolkit (NLTK) | | | | | |
| “Content-aware” chunking: Recursive | 0.79 | 0.59 | 0.89 | 0.76 | 0.79 |
| Chunking (using set of separators: | | | | | |
| “\n\n”, “\n”, “”, “”]) | | | | | |

Table 3 illustrates a RAG model with different chunk size comparison, according to an embodiment.

TABLE 3

| | | Precision | | Recall | |
|---|---|---|---|---|---|
| Description (Chunk Size, | | Unweighted* | Weighted* | Unweighted* | Weighted* |
| Overlapping Size) | Accuracy | (Equal) | (Major) | (Equal) | (Major) |
| Chunk Size: 1000, Overlap: 100 | 0.78 | 0.67 | 0.88 | 0.81 | 0.78 |
| Chunk Size: 512, Overlap: 20 | 0.85 | 0.66 | 0.90 | 0.86 | 0.85 |
| Chunk Size: 256, Overlap: 20 | 0.78 | 0.57 | 0.88 | 0.76 | 0.78 |

Table 4 illustrates a RAG model comparison using different embedding models for data processing, according to an embodiment.

TABLE 4

| | | Precision | | Recall | |
|---|---|---|---|---|---|
| | | Unweighted* | Weighted* | Unweighted* | Weighted* |
| Description | Accuracy | (Equal) | (Major) | (Equal) | (Major) |
| OpenAI Embedding | 0.79 | 0.59 | 0.89 | 0.76 | 0.79 |
| Hugging Face Embedding | 0.85 | 0.66 | 0.90 | 0.86 | 0.85 |

Table 5 illustrates a RAG model with different input additional documents, according to an embodiment.

TABLE 5

| | | Precision | | Recall | |
|---|---|---|---|---|---|
| | | Unweighted* | Weighted* | Unweighted* | Weighted* |
| Description | Accuracy | (Equal) | (Major) | (Equal) | (Major) |
| SLB Oil & Gas Glossary | 0.66 | 0.52 | 0.86 | 0.76 | 0.66 |
| SPE Glossary | 0.64 | 0.47 | 0.85 | 0.73 | 0.64 |
| SLB Oil & Gas Glossary + | 0.63 | 0.45 | 0.86 | 0.71 | 0.63 |
| SPE Glossary | | | | | |
| 4,000 DDR Remarks | 0.79 | 0.64 | 0.88 | 0.79 | 0.79 |
| 4,000 DDR Remarks + 1 shot | 0.82 | 0.67 | 0.89 | 0.81 | 0.82 |
| examples & explanations | | | | | |
| 22,000 DDR Remarks | 0.85 | 0.66 | 0.90 | 0.86 | 0.85 |

Table 6 illustrates a comparison of a fine-tuned cloud and LLM, according to an embodiment. This compares the results by fine-tuning the local LLM model, Llama2 13B Chat and the cloud base LLM model, and GPT 3.5 Turbo. The cloud base LLM performs better on the same task. The data for fine-tuning using GPT3.5 Turbo is 1-fold less than the local LLM.

TABLE 6

| | | Precision | | Recall | |
|---|---|---|---|---|---|
| | | Unweighted* | Weighted* | Unweighted* | Weighted* |
| Description | Accuracy | (Equal) | (Major) | (Equal) | (Major) |
| Zero Shot Fine Tuned GPT | 0.90 | 0.84 | 0.90 | 0.82 | 0.90 |
| 3.5 Turbo Training and | | | | | |
| validation samples: ~517 | | | | | |
| Zero Shot Fine Tuned | 0.91 | 0.76 | 0.92 | 0.72 | 0.91 |
| Llama2 13B Training and | | | | | |
| validation samples: ~1,395 | | | | | |

There are a few hyperparameters may enhance the local LLM model fine tuning performance:
1. Input prompt data format
2. Input system prompt length
3. Learning scheduler
4. Rank
5. Alpha
6. Maximum sequence length
7. Maximum step

Table 7 illustrates a summary of the results, according to an embodiment.

TABLE 7

| | | Precision | | Recall | |
|---|---|---|---|---|---|
| | | Unweighted* | Weighted* | Unweighted* | Weighted* |
| Description | Accuracy | (Equal) | (Major) | (Equal) | (Major) |

Before Fine Tuning

| | | | | | |
|---|---|---|---|---|---|
| GPT-4 One Shot | 0.81 | 0.72 | 0.87 | 0.80 | 0.81 |
| GPT-4 RAG Zero Shot | 0.85 | 0.66 | 0.90 | 0.86 | 0.85 |
| GPT-3.5 Turbo One Shot | 0.47 | 0.52 | 0.69 | 0.54 | 0.47 |
| LLama2 13B One Shot | 0.28 | 0.05 | 0.22 | 0.13 | 0.28 |

After Fine Tuning

| | | | | | |
|---|---|---|---|---|---|
| Fine Tune GPT3.5 Turbo - | 0.90 | 0.84 | 0.90 | 0.82 | 0.90 |
| Zero Shot | | | | | |
| ~317 samples for training | | | | | |
| ~200 samples for validation | | | | | |
| Fine Tune LLama2 13B - | 0.91 | 0.76 | 0.92 | 0.72 | 0.91 |
| Zero Shot | | | | | |
| ~1,395 samples for training | | | | | |
| Tune 1.84% of all trainable | | | | | |
| parameters | | | | | |

### Project Deliverables

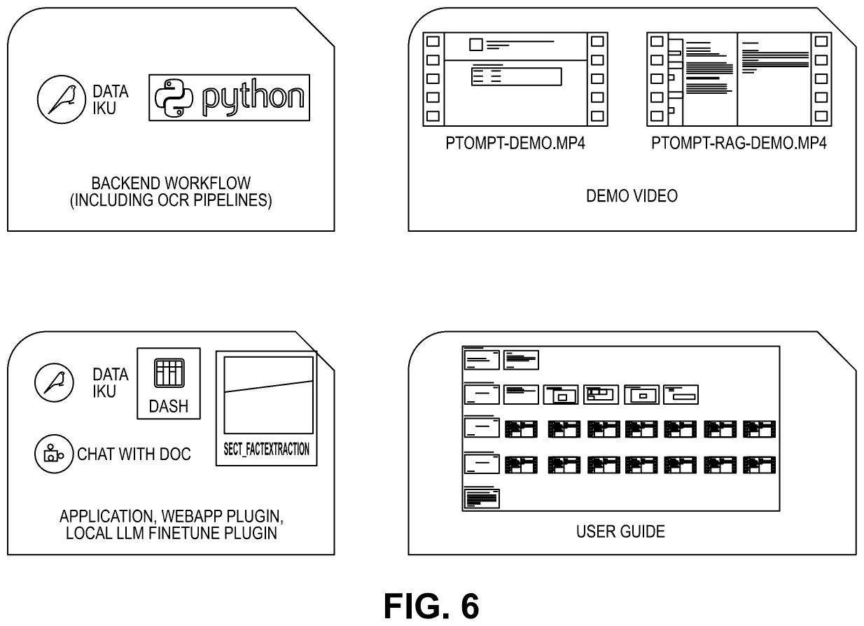

FIG. 6 illustrates a schematic view of project deliverables, according to an embodiment. A web application may be used that allows multi-user access with the pipeline to enable users to select either the prompt model, the RAG model, or the GPT3.5 Turbo fine-tune model to perform their desire task.

Other Use Cases—This workflow and application have been further tested and validated for several use cases:
1. DDR with other formats from Utah FORGE well and Santos public report
2. French report for translation and summarization
3. Scanned DDR reports
4. Finance economics Excel
   Retrieving Operation Insights with GenAI LLM: Comparative Analysis and Workflow Enhancement

The method may help to identify drilling risks for upcoming wells based upon demands and insights from offset wells. While some risks may lead to non-productive time (NPT), others remain latent within daily drilling reports (DDRs), which may be helpful for comprehensive analysis. Manual extraction from DDRs is often time-consuming. Thus, the method leverages GenAI LLMs with enhanced workflows to automate insights extraction and improve risk identification accuracy. The LLMs customization approaches were compared with conventional NLP models to validate the efficiency of the LLMs in the drilling domain.

The prompt instructions context may be modified (e.g., optimized) for the GPT-4 model using prompt engineering techniques and Retrieval Augmented Generation (RAG) methods. This strategy addresses concerns regarding hallucinations and knowledge cutoffs. This may be achieved by refining instructions for improved prompt engineering and establishing a RAG workflow to construct a domain-specific knowledge base. Additionally, the model performance may be enhanced by fine-tuning the GPT 3.5 Turbo and employing Parameter Efficient Fine-Tuning (PEFT) on the quantized Llama213B chat model. These models may be integrated into a web application to automate the extraction of drilling risks with enhanced confidence.

The adaptation of prompt and RAG techniques shows an improvement over the conventional oil and gas fine-tuned GPT-2 model, particularly in addressing rare drilling event classes where the conventional model struggles due to limited training examples. However, larger models like GPT-4 demonstrate improved generalization and reliability for both major and minor drilling event classes. Both prompt and RAG models now achieve an accuracy ranging from 80-85%, with precision and recall surging from less than 50%, as observed in the conventional model, to over 70% for the customized model. Notably, the fine-tuning of the GPT 3.5 Turbo model resulted in a further accuracy boost up to 91%, with precision and recall surpassing 80%.

Subsequently, the fine-tuned on-premises language model (e.g., Llama213B chat model) also exhibits promising outcomes. Despite achieving similar accuracy levels, it displayed slightly lower precision and recall compared to the GPT 3.5 Turbo, yet still surpassing 70%. These enhancements instill greater confidence in decision-making based on extracted results, ultimately elevating stakeholder satisfaction. This was implemented to a field with 180 DDRs from 24 wells. Nearly 7% of hidden events from 85% drilling remarks were uncovered that were not captured with NPT events. Manual review takes about a month at 6 reports per day, while automation takes 0.5 seconds per report, totaling 1.5 to 2 hours for the hidden events discovery.

Thus, the method includes a prompt design, enhanced RAG workflow, and the local LLM fine-tuning. These components may be integrated into a web application, empowering engineers to extract operation insights from reports with customizable prompt template. The enhanced workflow increased the analysis confidence and outperformed the benchmark fine-tuned oil and gas GPT-2 model.

As discussed above, the method may help to identify drilling risks for upcoming wells based upon demands and insights from offset wells. While some risks may lead to non-productive time (NPT), others remain latent within daily drilling reports (DDRs), which is helpful for comprehensive analysis. Manual extraction from DDRs is often time-consuming. The present disclosure explores the methods to leverage the Large Language Models (LLMs) with enhanced workflows to automate insights extraction and improve risk identification accuracy. The LLMs customization approaches were compared with conventional NLP models to validate the efficiency of the LLMs in the drilling domain. The adaptation of prompt optimization (e.g., Retrieval Augmented Generation (RAG) with the pre-trained LLMs before fine-tuning the model) already shows an improvement, achieving an accuracy ranging from 80-85%, with precision and recall surging from less than 50%, as observed from the conventional oil and gas finetuned GPT-2 model, to over 70% with the customized model. The challenge of imbalance training examples is addressed during the fine-tuning of the state-of-the-art GPT-2 model, which caused the underperformance of the conventional model, particularly in addressing rare drilling event classes.

The present disclosure demonstrates that LLMs are able to improve the generalization and reliability of the imbalance drilling risks, with proper workflow enhancements. Subsequently, both on-premises LLMs (Llama2, Llama3, Mistral) and cloud LLM GPT-3.5 Turbo may be optimized, which exhibits promising outcomes, achieving better performance to over 90% accuracy, and over 80% precision and recall, compared to the earlier approach using prompt and RAG. The method advances the application of LLMs in the oil and gas industry, for domain-specific tasks, addressing the common challenge of imbalanced operation training data, and demonstrating that enhanced workflows outperform both the conventional fine-tuned GPT-2 model, pretrained GPT-4 model, and the fine-tuned GPT-3.5 Turbo.

### 1 Introduction

In the upstream oil and gas industry, optimizing operational costs by monitoring Non-Productive Time (NPT) is helpful, as drilling capital expenditure may constitute 24-27% of the operator's drilling budget and can account for up to 40% of the total well cost. Operational insights, including parameters, tool details, and remarks, are predominantly found in offset well DDRs. These insights are helpful for engineering domains such as drilling, geomechanics, and reservoir engineering. Conventional methods of extracting these insights are manual and time-consuming, posing challenges for efficient risk identification and operational planning. For example, the extracted drilling risks are beneficial for drilling engineer to perform their on-job planning, geomechanics engineer to calibrate their post-drill 1D Mechanical Earth Model (MEM), and reservoir engineer to plan the infill well placements, for next drilling campaign. Manual extraction from DDRs is often time-consuming, reducing risk identification quality. Thus, the effort in automating the insights retrieval from these reports was started a few years ago with the evolution of Natural Language Processing (NLP) and Language Model (LM). However, the automated insights extraction is not straightforward due to the variation of report template from different operators. Additionally, the existing LM often involves extensive labelling for supervised learning, as they may underperform for infrequently encountered drilling risk cases due to a lack of training samples—an approach that is expensive.

With the emergence of large language models (LLMs) and their remarkable progress since 2020, following the release of OpenAI's ChatGPT, their efficiency and potential applications in the oil and gas industry have been evaluated. Multiple surveys have been published on the capabilities of LLMs in various NLP tasks such as information retrieval, speech recognition, machine translation, and other downstream tasks, providing a holistic overview of LLMs.

Additionally, recent developments from various authors have introduced different LLM families. However, there is still lacking a comprehensive review on the LLM application in the oil and gas industry. The present disclosure presents the first comparative analysis of domain customization of LLMs in the upstream petroleum industry, specifically focusing on retrieving the operation insights such as drilling risks from DDR. This study evaluates the LLM performance in three main stages: (1) the pre-training stage, utilizing the foundation model without domain-specific context injection; (2) the post-training stage, incorporating in-context learning (ICL), also known as parameter-frozen alignment to integrate specific domain knowledge; and (3) the downstream finetuning stage, employing quantized adapter-based Parameter-Efficient Finetuning (PEFT) techniques. Notably, workflow enhancements were particularly applied during the post-training and downstream finetuning stages, to overcome the challenges of conventional NLP approaches, such as the technical vocabulary, limited training data, and weak memory. A comparative analysis of these stages highlights the effectiveness of these enhancements.

This research aims to revolutionize the extraction of operational insights from unstructured documents in the oil and gas industry, unlocking valuable information hidden within operations reports with advanced LLM framework. The contributions of this work can be summarized as follows: (1) First oil and gas domain customized LLM survey: This is the first comparative analysis on the LLM application in oil and gas industry; (2) Novel workflow enhancement: A domain prompt context, domain RAG workflow, and domain finetuned LLM are created to increase the LLM performance for domain insights retrieval workflow; (3) Extensive research: The impact of prompt design, effect of datatypes, chunking strategies, embedding models, and vector databases type for the RAG pipeline are studied.

### 2 Preliminary

### 2.1 Language Models (LM)

A language model is a probabilistic model of a natural language. Suppose there is a sentence “the cat sat on the mat.” This can be represented as a sequence of words: w1, w2, . . . , wn, where wi represents the ith word. The goal of a language model is to estimate the probability of a sequence P(w1, w2, . . . , wn). Language models are widely used in a variety of natural language processing tasks, such as speech recognition, machine translation, text generation, question-answering systems, etc.

With the advancement of deep learning technology, language models have evolved from simple N-gram models to Recurrent Neural Network (RNN) models that use loop structures to capture long-term dependencies. Long Short-Term Memory networks (LSTM) have also been widely used. As an early attempt of Pre-trained Language Model (PLM), ELMo was proposed to capture context-aware word representations. It first pre-trained a bidirectional LSTM (biLSTM) model and then fine-tuned this model based on a specific downstream task. Building upon the highly parallelizable transformer architecture with self-attention mechanism was proposed by pre-training a bidirectional language model using a specially designed pre-training task on a large-scale unlabeled corpus. This research inspired a large number of subsequent works and established the “pre-train and fine-tune” learning paradigm. Following this paradigm, researchers introduced different architectures (such as GPT-2 and BART).

### 2.2 Large Language Models (LLM)

Many studies have explored the performance limits by training increasingly larger PLMs (e.g., GPT-3 with 175B parameters and PaLM with 540B parameters). While scaling is primarily done in model size, these large PLMs exhibit different behaviors from smaller PLMs (e.g., BERT with 330M parameters and GPT-2 with 1.5B parameters) and demonstrate surprising capabilities in solving a range of complex tasks. As a result, the research community coined the term “large language models (LLMs)”1 for these large PLMs, and they have attracted increasing research attention.

Large language models are deep learning models designed to understand and generate natural language. They are characterized by their large size, including a large number of parameters and large training datasets, and their excellent learning ability. The core module behind many LLMs (such as GPT-3, InstructGPT, and GPT-4 (OpenAI 2023) is the self-attention module in the transformer, which is a fundamental building block for language modeling tasks. The transformer revolutionized the field of NLP with its ability to efficiently process sequential data, allowing parallelization and capturing long-range dependencies in text.

The training process for LLM models such as ChatGPT, Llama, and Falcon consists of several key stages. It starts with a stage called pre-training, in which these models are exposed to large and diverse datasets of internet text, allowing them to learn grammar, vocabulary, world knowledge, and context. After pre-training, the models are fine-tuned on specific datasets for specific tasks. Fine-tuning refines their ability to accomplish these specialized tasks and optimizes performance through hyperparameter tuning.

### 3 Data Resource

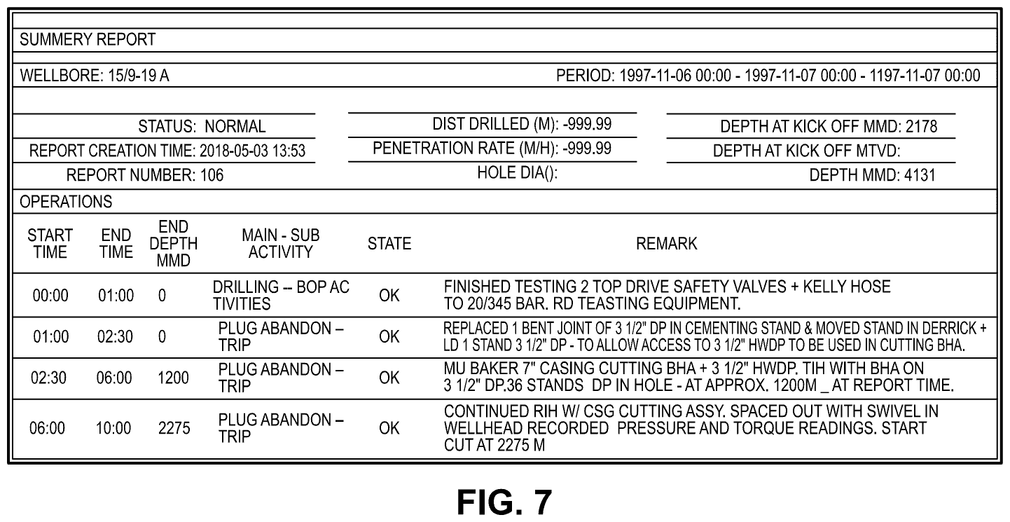

The present disclosure solves the problem of automatically obtaining relevant information from Daily Drilling Reports (DDR). The GPT model is utilized along with advanced techniques like prompt engineering and RAG to enhance model performance. These techniques were helpful in refining the model's ability to extract and interpret drilling risks from the DDRs efficiently. FIG. 7 illustrates a part of the DDR, according to an embodiment. The method may collect drilling-related information from it, such as: start time, end time, depth and remark, then predict the possible drilling risk based on the remark.

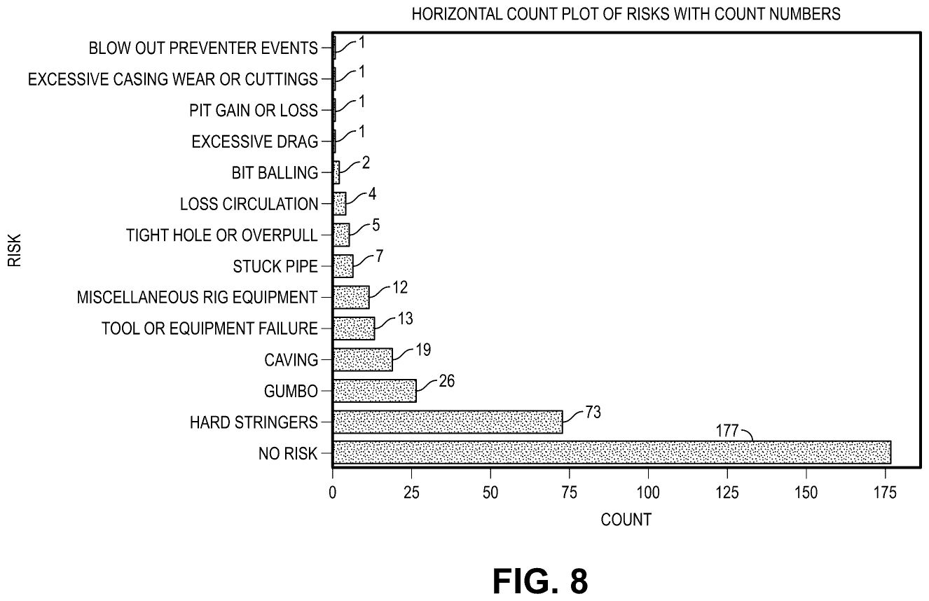

In this example, there are 178 DDR files. A drilling engineer has labelled 13 drilling risk and no risk for each table row of data to obtain 1742 valid labeled data. For each risk label, 20% of the data was randomly selected, resulting in a total of 342 samples for experimentation. This selection process ensures a representative distribution of data, allowing for robust evaluation of the model's performance. FIG. 8 illustrates the distribution of the drilling risk samples, according to an embodiment.

### 4 LLM Sequential Customization & Workflow Enhancement

Until 2020, fine-tuning was the dominant approach for adapting models to specific tasks. However, large models such as GPT-3 have demonstrated that similar results can be achieved through prompt engineering, where the user designs and provides specific prompt text to guide the LLM to generate a desired response or complete a specific task. In-Context learning (ICL) is a powerful feature of Large Language Models (LLMs), which involves providing the model with some examples of how to perform a task (often referred to “demonstrations” or “shots”), and then providing the model with new instances of the same task to solve. The model then uses the patterns inferred from the examples to generate responses for the new instances, without the model being explicitly trained on those tasks.

The development of foundation models has been an advancement in the field of machine learning, providing a powerful starting point for a wide range of applications. As these models continue to grow in complexity and capabilities, researchers and developers have explored various ways to further enhance their performance.

### LLM Sequential Customization

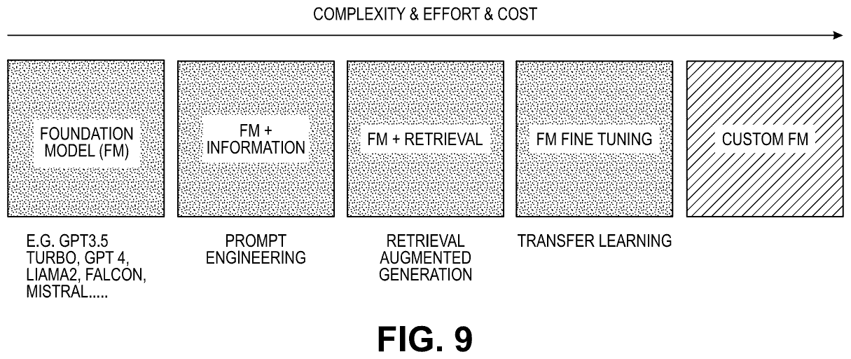

FIG. 9 illustrates a schematic view of a LLM sequential customization workflow, according to an embodiment. Adding prompt information to the foundation model can help specialize it for particular tasks, while RAG mechanisms allow the model to access and integrate external knowledge sources. The process of fine-tuning the foundation model on task-specific data is helpful, as it enables the model to adapt to the unique requirements of a given problem. However, as the complexity of these models increases, so does the cost and time required for their development. The fine-tuning and customization processes also demand substantial expertise and careful consideration to ensure the models are optimized for the intended applications.

4.1 Direct Prompting using Pretrained LLM

Prompt engineering is a technique in the field of natural language processing (NLP), which focuses on designing effective prompts to guide the behavior of language models. The goal is to influence the output of the model to make it more accurate, coherent, and relevant to the intended application.

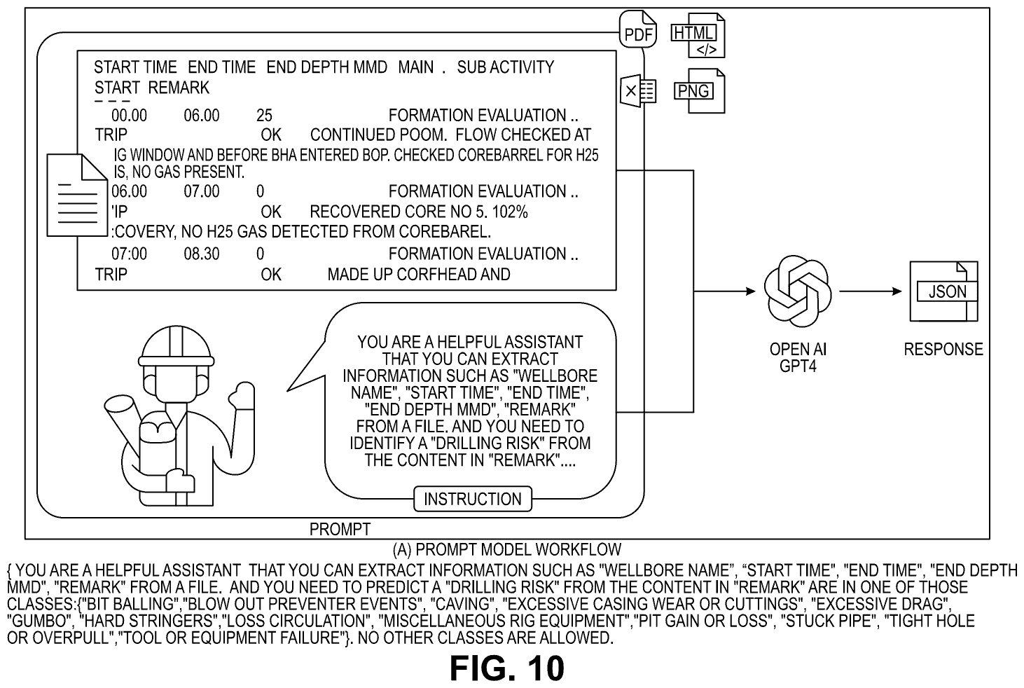

FIG. 10 illustrates a prompt model workflow, according to an embodiment. Initially, Optical Character Recognition (OCR) technology may be utilized to convert the textual content from DDRs into a machine-readable format. This step is helpful for ensuring that the relevant information is accurately captured and can be subsequently processed by the LLMs. As illustrated in FIG. 10, the extracted text is then provided as input, along with a crafted prompt, to the GPT-4 language model. For the prompt, a guiding agent may instruct the model about the objective. Specifically, the model may be informed that one goal is to extract relevant information from the DDR. Additionally, the model may be provided with a predefined list of target risk labels. The model may then be explicitly instructed to focus its predictions on the given labels, without generating any other risk assessments.

For the direct prompting experiments, a zero-shot method may be adopted, which may associate observed and unobserved categories through some form of auxiliary information. Zero-shot prompting involves asking a model to perform a task without providing any examples. The model relies entirely on its pre-existing knowledge and reasoning abilities to generate a response. When performing zero shot testing, the DDR and instructions may be input to the model, and the model may not be provided with any labeled examples. For the result with 342 test data, 61% accuracy was achieved.

### 4.2 Domain Specific In-Context Learning

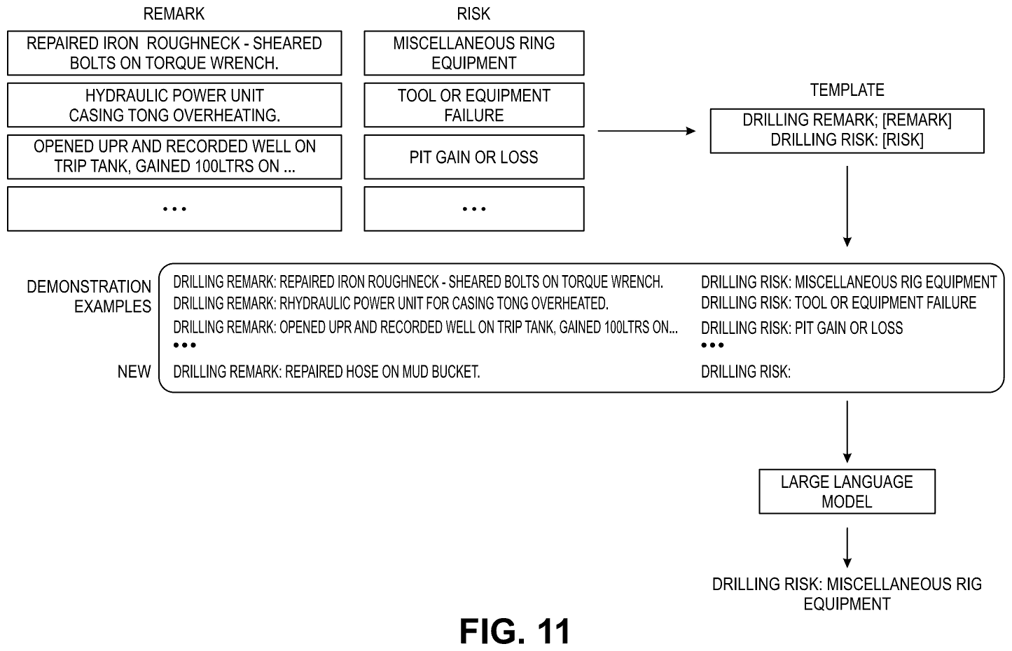

As the model size and data size scale, large language models (LLMs) demonstrate in-context learning (ICL) capabilities, where the idea is to learn from analogies. FIG. 11 illustrates an in-context learning process that shows how a language model makes decisions through ICL, according to an embodiment. First, ICL uses some demonstration examples to form a prompt context. Then, ICL concatenates the query question and the prompt context to form the input, which is then fed into the language model for prediction. ICL is a training-free learning framework. This reduces the computational cost of adapting the model to new tasks and makes language models as a service possible and can be easily applied to large-scale real-world tasks.

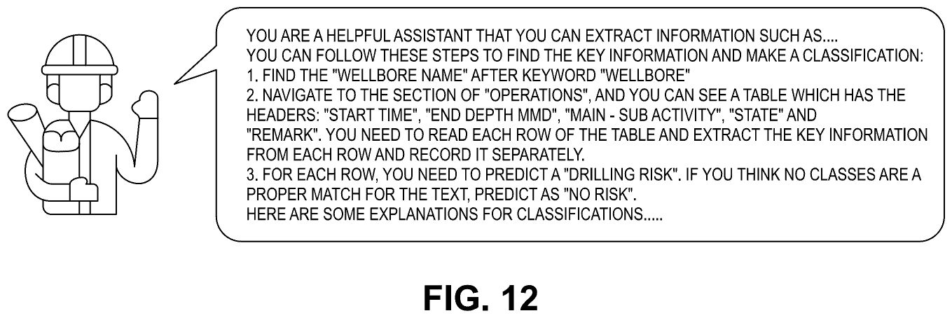

Although promising, there are also some interesting problems and interesting properties in ICL that could benefit from further study. For example, the performance of ICL is sensitive to specific settings, including the cue template, the choice and order of demonstration examples, and other factors. Based on the location of the drilling-related table depicted in FIG. 7, the language model may be provided with specific instructions to guide its information retrieval process, which uses chain-of-thought idea. FIG. 12 illustrates a chain-of-thought idea for ICL, according to an embodiment. This approach exploits the model's ability to follow structured guidelines, allowing it to systematically locate and extract data from provided sources. The language model may also be supplied with explanatory descriptions for each of the target risk labels or classes. Associating these detailed explanations with the corresponding labels may help the model develop a deeper understanding of the concepts and their distinguishing characteristics.

Large language models (LLMs) can be sensitive to adversarial prompts, so it is helpful to carefully design prompts to achieve better performance. To address this, one or more methods may be used to improve model's performance, such as: adding label explanations in the prompt and utilizing the chain of thought idea. Moreover, one-shot and/or few-shot prompts may be used, which are techniques used in natural language processing (NLP) to teach large language models (LLMs) how to perform tasks or generate responses without being explicitly trained on those tasks. These techniques involve providing varying numbers of examples in the prompt to guide the model's behavior.

4.2.1.1 One-shot and Few-shot prompt

One-shot or few-shot prompts allow LLMs to adapt to new tasks or domains with minimal training data. The idea behind one-shot or few-shot prompt is to provide a language model with a single or a few examples of a desired task or output, and then have the model generate new outputs based on this limited information. In conventional machine learning settings, training a model to perform a new task involves a large dataset of labeled examples. However, a one-shot prompt circumvents using large datasets by leveraging the model's ability to quickly learn and generalize from a small number of examples.

In a language model, these two approaches may be adopted to enhance the ability to accurately classify the 13 risk and the “no risk” labels. First, a one-shot prompt may be used to provide the model with a single example and explanation for each of the 14 target classes. This one-shot prompt may be designed to provide the model with a concise and informative introduction to the semantics and distinguishing features of each label. Building on the one-shot prompt, few-shot prompts may be tested that include a small set of additional examples for categories that are more confusing or could use further clarification.

### 4.2.1.2 Prompt Tuning Optimization

After exploring various prompt engineering input, it was found that the model achieves optimal performance when the prompt contains the following components:
Objective: A clear and concise description of the task or desired output, which helps the model understand the overall goal.
Chain-of-Thought Steps: Encouragement for the model to break down the problem into intermediate reasoning steps, showcasing its thought process. This can lead to more reliable and explainable outputs.
Label Explanation: Detailed explanations of the labels or categories involved in the task, which helps the model better comprehend the meaning and context of the output.
Label Example: Providing a sample or example of the expected label, which serves as a reference for the model to generate more accurate and consistent responses.

The specific metric results demonstrating the effectiveness of this prompt structure can be found in Table 8.

TABLE 8
Zero-shot, One-shot, Few-shot prompt result (342 samples)

| | | Precision | | Recall | |
|---|---|---|---|---|---|
| | | Unweighted | Weighted | Unweighted | Weighted |
| Model | Accuracy | (Equal) | (Major) | (Equal) | (Major) |

| | | | | |
|---|---|---|---|---|
| Zero Shot No examples & | 0.61 | 0.57 | 0.80 | 0.61 |
| Explanations | | | | |
| One Shot 1 example for each | 0.66 | 0.62 | 0.83 | 0.66 |
| category & no explanations | | | | |
| One Shot 1 example for each | .081 | 0.72 | 0.87 | 0.81 |
| category & add explanation | | | | |
| for each category | | | | |
| Few Shot 2 examples for each | 0.60 | 0.52 | 0.84 | 0.60 |
| category & 2 explanations for | | | | |
| each category | | | | |

### 4.3 Retrieval Augmented Generation (RAG)

The challenge of knowledge truncation is particularly acute when applying large language models (LLMs) to domain-specific problems. This problem stems from the fact that LLMs are primarily trained on large and diverse general corpora, often lack domain-specific depth, and contain content up to a specific training checkpoint. As a result, when faced with domain-specific queries or tasks, LLMs may struggle to provide accurate or relevant responses because they have limited exposure to domain-specific nuances, terminology, context, and recent content. For example, the term “Christmas tree” can have different meanings in different contexts. In a general context, it represents a decorated Christmas tree, but in the energy industry, it refers to wellhead components used in oil and gas production.

This is relevant in the energy industry because precise answers can profoundly impact decisions and outcomes, such as optimizing energy production, ensuring operational efficiency, or meeting regulatory standards. In these scenarios, relying solely on general LLMs without domain-specific knowledge is simply insufficient.

To address the challenges of this problem, the method may use the Retrieval-Augmented Generation (RAG) technique as a complementary approach. The RAG framework combines the strengths of LLMs with information retrieval capabilities, enabling the model to generate more informed and contextually appropriate outputs.

### RAG Model

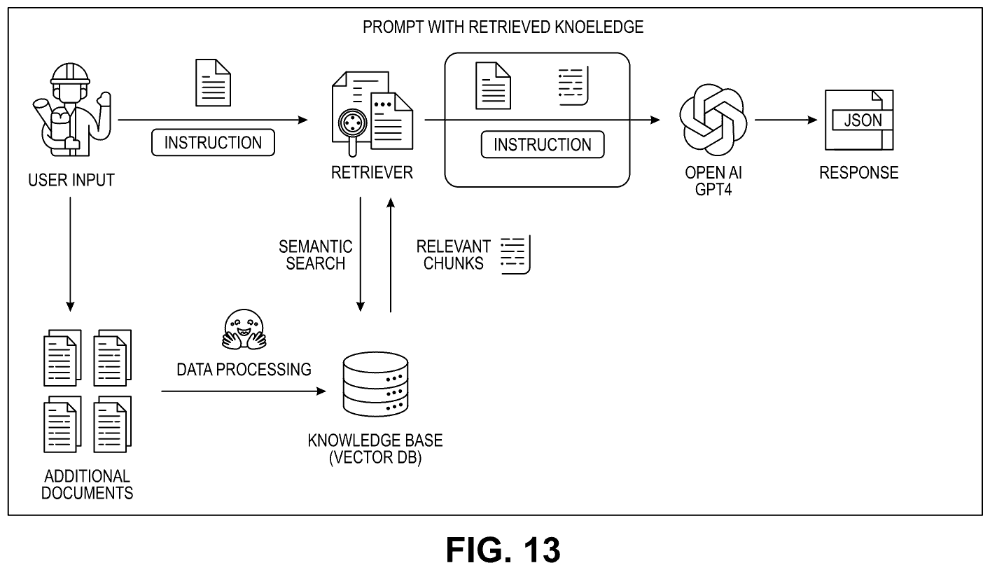

FIG. 13 illustrates a prompt with the RAG model, according to an embodiment. More particularly, the core idea behind RAG is to seamlessly integrate retrieval capabilities into the language generation process, as shown in FIG. 13. Instead of relying solely on the internal knowledge of the LLM, the RAG model can dynamically retrieve relevant information from external knowledge sources (e.g., using additional documents related to the oil & gas domain) instead of relying solely on the internal knowledge of the LLM. This enables the model to enrich its understanding and better base its responses on factual information.

In implementing the RAG technique, a LangChain retriever may be used. This tool integrates information retrieval into the language generation process, enhancing the model's ability to provide contextually accurate and relevant responses by accessing external knowledge sources. The retrieval workflow consists of two steps:
Semantic Search: The LangChain retriever first takes the user's input (e.g., DDR and prompt instruction) as a search query and performs a semantic search operation on the knowledge base. This enables the retriever to identify the most relevant information that is contextually consistent with the user's request.
Generation Guidance: After retrieving relevant information, the LangChain retriever seamlessly integrates this data into the generation process of the language model. The retrieved information is used to enhance the user's original input, providing the language model with additional context, facts, and details to guide its generation. This helps the model generate more accurate, informative, and coherent responses based on the retrieved knowledge.

### 4.3.1 Additional Documents

As a preparatory step for the RAG approach, oil-related documents may be compiled and processed to produce a comprehensive knowledge base. In one example, the documents may be from:
SLB Oil & Gas Glossary (SLB Energy Glossary 2023): The Energy Glossary, which contains more than 4,800 definitions, is reviewed by SLB technical experts. Definitions are constantly updated to ensure accuracy while maintaining objectivity, and new information is added as industry news and technology evolve.
SPE Glossary: More than 3,400 definitions of various terms may be collected from glossaries on well-known websites in the oil and gas industry using web scraping tools. The definitions collected from different sources were integrated to create a comprehensive glossary for the oil and gas sector, covering a wide range of technical terms related to exploration, drilling, production, and refining activities.
DDR Remarks: More than 22,000 drilling reviews may be collected from various industry sources and field operations and used to build a comprehensive dataset. Drilling reviews cover a wide range of information, including technical details, operational updates and field observations.

Table 9 shows results comparing different input documents to build a vector database. The metrics below include a chunk size 512, an overlap size 20. Hugging face embeddings and a recursive chunking strategy were used.

TABLE 9

| | | Precision | | Recall | |
|---|---|---|---|---|---|
| | | Unweighted | Weighted | Unweighted | Weighted |
| Description | Accuracy | (Equal) | (Major) | (Equal) | (Major) |
| SLB Oil & Gas Glossary | 0.66 | 0.52 | 0.86 | 0.76 | 0.66 |
| SPE Glossary | 0.64 | 0.47 | 0.85 | 0.73 | 0.64 |
| SLB Oil & Gas | 0.63 | 0.45 | 0.86 | 0.71 | 0.63 |
| Glossary + SPE Glossary | | | | | |
| 4,000 DDR Remarks | 0.79 | 0.64 | 0.88 | 0.79 | 0.79 |
| 22,000 DDR Remarks | 0.85 | 0.66 | 0.90 | 0.86 | 0.85 |

### 4.3.2 Data Processing

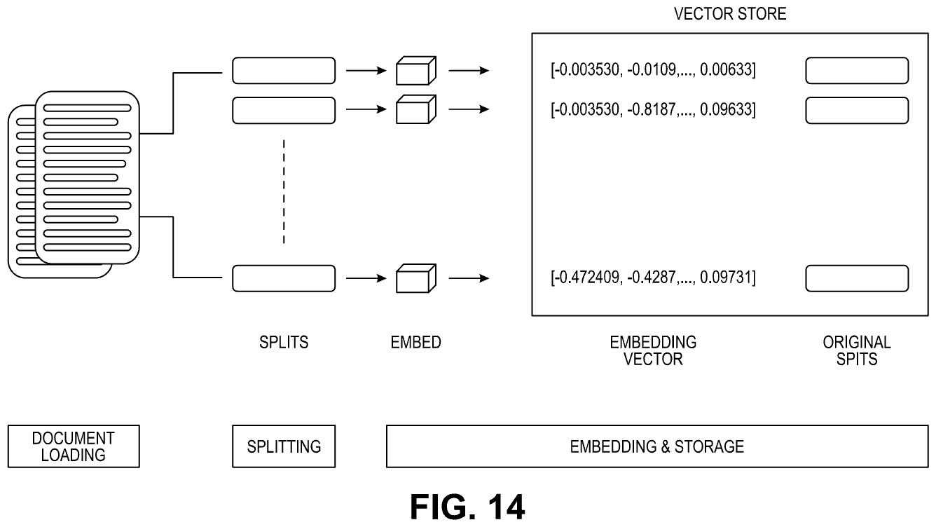

FIG. 14 illustrates a workflow to create a knowledge database, according to an embodiment. There are several technical issues in building an effective knowledge base. These considerations include the document chunking strategy for document type, the splitting method to store in the database, determination of the optimal chunk size, and the embedding model used to convert these chunks into embeddings or numerical representations (FIG. 14).

### 4.3.2.1 Data Splitting Method

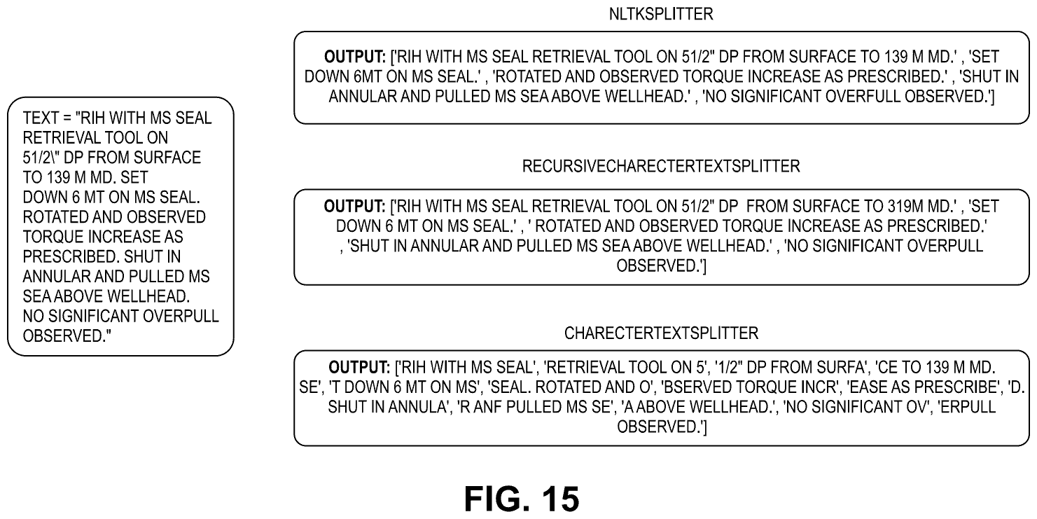

To optimize the data processing process, various techniques and approaches were explored. The NLTK library uses pre-trained models to identify sentence boundaries based on punctuation and other linguistic cues. This splitter is useful to break down text into smaller, semantically meaningful units sentences rather than arbitrary character-based chunks. The recursive text splitter is a part of the LangChain library and provides a more advanced text splitting approach. It recursively splits the input text into smaller chunks until the desired chunk size is achieved. It supports various splitting strategies, such as splitting by characters, words, or sentences, and can handle different types of text, including structured and unstructured data. The character text splitter is used to split the loaded data into smaller chunks or passages. The chunk size parameter determines the maximum length of each chunk, and the chunk overlap parameter specifies the overlap between adjacent chunks. This chunking process helps the retriever handle longer input texts more efficiently. FIG. 15 illustrates examples of the output produced by three different text splitters, according to an embodiment.

The results of different splitters may be found in Table 10.

TABLE 10
Results comparing different chunk strategies. The metrics below include a chunk size
512, an overlap size 20, using OpenAI embeddings and input 22,000 DDR remarks.

| | | Precision | | Recall | |
|---|---|---|---|---|---|
| | | Unweighted | Weighted | Unweighted | Weighted |
| Description | Accuracy | (Equal) | (Major) | (Equal) | (Major) |
| CharacterTextSplitter | 0.75 | 0.60 | 0.88 | 0.83 | 0.75 |
| NLTK Splitter | 0.73 | 0.59 | 0.88 | 0.80 | 0.73 |
| RecursiveTextSplitter | 0.79 | 0.59 | 0.89 | 0.76 | 0.79 |
| (using set of separators: | | | | | |
| “\n\n”, “\n”, “”) | | | | | |

### 4.3.2.2 Data Chunk Strategy

Alongside the text splitting methods, the values of the chunk size and overlap parameters may be adjusted. The chunk size determines the maximum length of each individual text segment, while the overlap setting controls the amount of overlapping content between adjacent chunks. By modifying these parameters, the optimal balance between preserving contextual information and ensuring efficient processing of the input data may be determined. The results of different data chunk strategies can be found in Table 11.

TABLE 11
Result comparing different chunk size. Metric below with input 22,000:

| | | Precision | | Recall | |
|---|---|---|---|---|---|
| | | Unweighted | Weighted | Unweighted | Weighted |
| Description | Accuracy | (Equal) | (Major) | (Equal) | (Major) |
| Chunk params: 1000, 100 | 0.78 | 0.67 | 0.88 | 0.81 | 0.78 |
| Chunk params: 512, 20 | 0.85 | 0.66 | 0.90 | 0.86 | 0.85 |
| Chunk params: 256, 20 | 0.78 | 0.57 | 0.88 | 0.76 | 0.78 |

### 4.3.2.3 Data Embedding

Additionally, different text embedding approaches may be used, including Hugging Face embeddings and OpenAI embeddings. Text embeddings are numerical representations of words or phrases that capture their semantic and contextual information. By testing these alternative embedding methods, the most suitable representation of the textual data may be identified that enhances the performance of the downstream natural language processing tasks. The results of different embedding models can be found in Table 12.

TABLE 12
Results comparing different embedding models. Metric below with input 22,000 DDR
remarks, chunk size 512, overlap size 20, and recursive chunking strategies.

| | | Precision | | Recall | |
|---|---|---|---|---|---|
| | | Unweighted | Weighted | Unweighted | Weighted |
| Description | Accuracy | (Equal) | (Major) | (Equal) | (Major) |
| OpenAI Embedding | 0.75 | 0.60 | 0.88 | 0.83 | 0.75 |
| HuggingFace Embedding | 0.73 | 0.59 | 0.88 | 0.80 | 0.73 |

Different open-source vector databases were also compared, and the model performance difference is trivial. But the memory saving using Facebook AI Similarity Search (FAISS) is consuming 70% less memory compared to Chroma database. By considering the memory consumption and the effectiveness in vectorizing our task-specific domain knowledge base, the best parameters that were tested may be combined for better vectorization. In an example, this may include using 22,000 DDR remarks as input, recursive chunking strategy, chunk size of 512 characters, overlap size of 20 characters, and Hugging Face embedding models to build the FAISS vector database. Although the precision for minor drilling event class is reduced, overall, it gives better confidence on the major drilling event class and increases the recall of the minor drilling event class by 6%. The one-shot prompt may also be compared with zero shot RAG models, and the result can be found in Table 13.

TABLE 13
Comparing One-Shot Prompt vs Zero Shot RAG

| | | Precision | | Recall | |
|---|---|---|---|---|---|
| | | Unweighted | Weighted | Unweighted | Weighted |
| Description | Accuracy | (Equal) | (Major) | (Equal) | (Major) |
| GPT-4 One Shot | 0.81 | 0.72 | 0.87 | 0.80 | 0.81 |
| GPT-4 RAG Zero Shot | 0.85 | 0.66 | 0.90 | 0.86 | 0.85 |

### 4.4 Fine Tuning Domain Specific LLMs

From the results of pretraining and post-training stages, it may be observed that the precision and recall are still less than 90% compared to the human evaluation benchmark. With insights from existing literature, it may be concluded that previous models underperformed due to the hindrance of LLMs with domain specific knowledge, and the inadequacies of post-training approach such as prompt tuning and RAG. The instability of LLM performance caused by context sensitivity with the need to identify better performing prompts, along with the limitations in retrieval quality using RAG approach, that depends on the relevance of the knowledge source, highlighted the constraints of in-context learning for a consistent and optimal results.

These challenges highlight the potential of finetuning the model as a more robust alternative to adapt LLM to domain knowledge. Performing full fine-tuning involves substantial computation resources and budgets, and focusing fine-tuning on a single task can lead to catastrophic forgetting phenomenon. This phenomenon causes the model to excel at the fine-tuned task but perform poorly on others. To address this, a parameter-efficient fine-tuning (PEFT) approach may be applied to specialize the pre-train LLMs to the drilling event categories. This process improves the accuracy in recognizing and categorizing drilling events using smaller-scale LLMs (7B/8B/13B), which have been shown to achieve superior performance compared to larger-scale LLMs (175B) in zero-shot inference. There are multiple approaches in PEFT training, including prompt-based learning, reparameterization, and series or parallel adaptation. The model weights may be reparametrized using a Quantized Low Rank Adaptation (QLoRA) technique to reduce the number of trainable parameters.

### Labeled Drilling Events

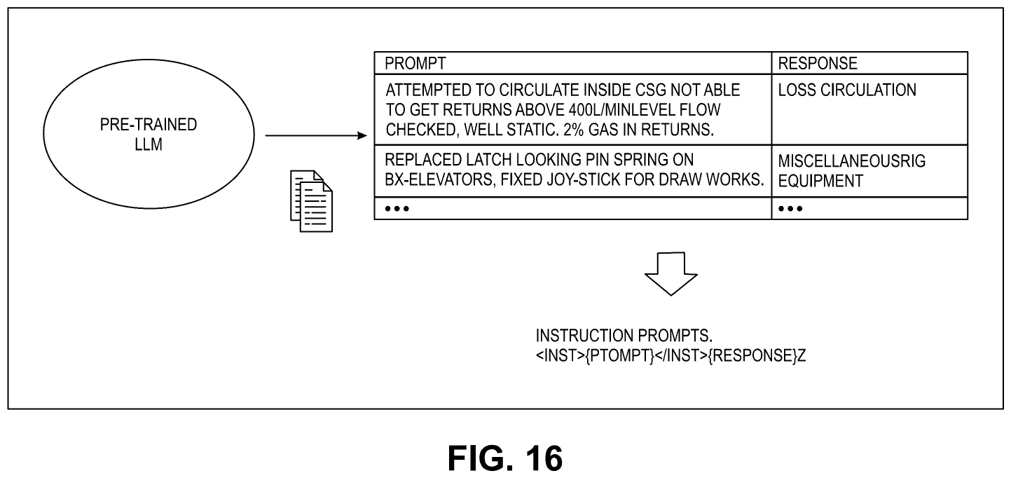

FIG. 16 illustrates the input set of labeled drilling event examples in the format of prompt-completion pair, with instruction prompt templates aligned with the LLM used for fine tuning, according to an embodiment. More particularly, FIG. 16 illustrates an instruction fine-tuning workflow, where a training dataset is converted to an instruction template in the format of a completion pair.

With QLoRA, most of the original model weights may be frozen while introducing two rank decomposition matrices, denoted as rank and alpha, to the adaptation layers, specifically the linear layers of the LLM. The rank signifies the dimensionality of the updated matrices, whereas alpha serves as a scaling factor, determining the impact of the adaptation layer's weights on the base mode l's parameters. By adjusting these variables, a user can precisely control the number of model weights subject to training, facilitating a balance between model size reduction and performance optimization. The model weight parameters reduced to 4-bit precision, and the rank decomposition of LoRA modules reduced the training parameters to 2-6% of the total number of trainable parameters. This method achieved memory reduction by a factor of eight, using a single on premises A100 GPU with 80 GB vRAM, while maintaining the model performance for the domain-specific task.

### PEFT Workflow

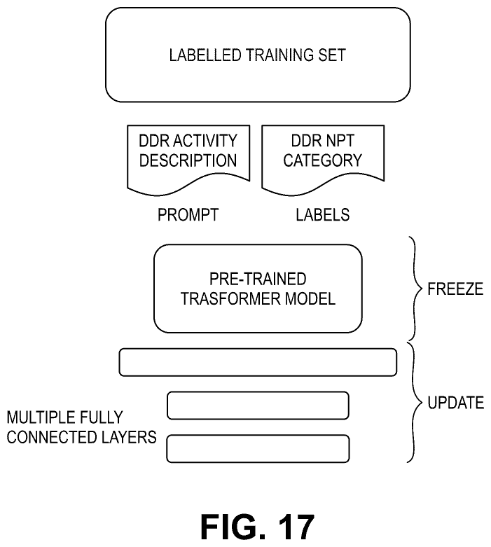

FIG. 17 illustrates a schematic view of a PEFT workflow for DDR event identification, according to an embodiment. For this study, 1740 remarks were labelled automatically using an existing NLP transformer, and the drilling risk labels as shown in FIG. 8 were validated by a drilling engineer. This data was then split with 80% (˜1400) drilling remarks for training and the remaining 20% (˜340) remarks used for validation and metrics comparison. The finetuning results were compared in 3 stages: (1) Cloud LLM: comparing GPT4, and GPT 3.5 Turbo; (2) On-Premises LLM: comparing the Llama2 13B, and Mistral 7B LLM before and after finetuning; (3) On-Premises LLM Finetuning with additional post processing: comparing the finetuned model with and without additional in-house post processing recipe.

### Precision and Recall

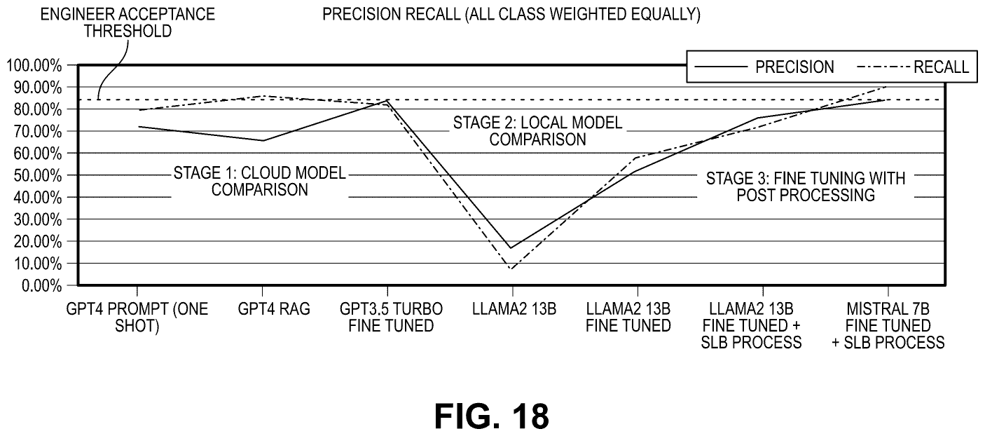

FIG. 18 illustrates a graph showing precision and recall evaluation (e.g., weighted—emphasize on major class, Unweighted—treat the classes equally). The dashed line represents the engineer workflow acceptance threshold, which should be greater than 85%. Based on internal discussions, the acceptable threshold for drilling risk identification automation, as determined by drilling engineers, is set at a minimum of 85%. This benchmark ensures that the automated system aligns with the accuracy and reliability standards for operational decision-making. Table 14 shows that the pretrained LLM using an ICL-like prompt with one-shot and RAG, achieves a recall greater than 80%. However, its precision is relatively low, compared to the GPT3.5Turbo after fine-tuning. This lower precision indicates the model has not seen enough examples from different drilling risk categories to generalize effectively. This underscores the importance of fine-tuning, as it allows the model to learn for more extensive and diverse drilling risk examples, thereby improving the precision to greater than 80%, and strike a balance with the recall metric. Due to the data residency concern, and the desire for a cost effective fine-tuning, the feasibility of fine-tuning an on-premises LLM with a smaller model size was evaluated.

From the results, it is evident that LLM model size is relevant, especially when the model is used for direct prompting. The larger model is generally exhibiting stronger language understanding and generation abilities that are not present in the smaller language model. Thus, if using smaller scale LLM, fine-tuning may enable the model to adapt better to the specific task. Performance improvements of a 35% increase in accuracy and over 40% improvement in both unweighted precision and recall were observed compared to the pre-trained smaller-scale LLM before fine-tuning. However, the performance is still not satisfactory without additional post-processing to constrain the model's outcome. An in-house post processing was applied with domain safeguards on the prediction results, to further enhance the reliability and accuracy of model's prediction by ensuring the results are consistent with the domain-specific expectation. The positive model performance advancement after post processing is motivating. Additionally, it may be seen that the Mistral 7B outperforms Llama2 13B, after applying similar post-processing techniques, and this aligned with the previously tested benchmarks for different general tasks, likely due to the advance model architecture of Mistral 7B.

Notably, it was observed that high-quality domain data fine-tuned with domain safeguards on the model outputs can overcome the controversy surrounding model size and model performance. A smaller fine-tuned LLM (7B) achieved better results compared to the finetuned GPT-3.5 Turbo (175B), showing a 3% improvement to the prediction accuracy, and generally better precision and recall across both weighted and unweighted metrics.

Table 14 shows a model comparison with a human benchmark evaluation.

TABLE 14

| | Precision | Recall | Precision | Recall | |
|---|---|---|---|---|---|
| Model | (unweighted) | (unweighted) | (weighted) | (weighted) | Accuracy |
| GPT-4 prompt (one shot) | 72.00% | 80.00% | 87.00% | 81.00% | 81.00% |
| GPT-4 RAG | 66.00% | 86.00% | 90.00% | 85.00% | 85.00% |
| GPT-3.5 Turbo finetuned | 84.00% | 82.00% | 90.00% | 90.00% | 90.00% |
| Llama2 13B model | 17.00% | 7.00% | 54.60% | 34.50% | 34.50% |
| Llama2 13B finetuned | 51.90% | 58.00% | 81.00% | 69.60% | 69.50% |
| Llama2 13B finetuned + | 76.00% | 72.00% | 92.00% | 91.00% | 91.00% |
| in-house post process | | | | | |
| Mistral 7B finetuned + | 84.60% | 89.80% | 95.20% | 94.20% | 94.00% |
| in-house post process | | | | | |

### 5 Model Performance Comparative Analysis

In summary, model performance and effectiveness was assessed using classification evaluation metrics, such as accuracy, precision, recall, and F1 score, within the context of human evaluation benchmarks, by comparing the prediction output with the domain expert's labels. The current adaptation of LLMs employing prompt and RAG techniques represents a leap forward compared to earlier NLP approaches or a previously fine-tuned oil and gas GPT-2 model used as benchmark.

The fine-tuned LM model exhibits suboptimal performance in terms of unweighted precision and recall. The model struggles to generalize across various drilling risk events, especially for minority class when the training data is insufficient, leading to high false positives and false negatives for the infrequent events. To overcome this limitation, the LLM may be customized. Table 15 shows LM versus LLM (pre-training, post-training, and fine-tuning. This is attributed to their extensive capacity and comprehensive understanding of diverse linguistic contexts, which enhances their performance in domain-specific tasks. By subsequently applying post-training and fine-tuning techniques, their performance may be further enhanced, ultimately identifying the optimal configuration for our domain specific task.

TABLE 15

| | | Precision | | Recall | |
|---|---|---|---|---|---|
| | | Unweighted* | Weighted* | Unweighted* | Weighted* |
| Description | Accuracy | (Equal) | (Major) | (Equal) | (Major) |

Stage (0): Pretrain LM & Oil& Gas Fine Tuned LM

| | | | | | |
|---|---|---|---|---|---|
| Finetuned Medium | 0.89 | 0.47 | 0.86 | 0.44 | 0.89 |
| Oil and Gas GPT-2 | | | | | |

Stage (1): Pretrain-LLM

| | | | | | |
|---|---|---|---|---|---|
| GPT-4 Zero Shot | 0.61 | 0.57 | 0.80 | 0.68 | 0.61 |
| Llama2-13B Zero Shot | 0.17 | 0.07 | 0.55 | 0.35 | 0.35 |

Stage (2): Post-Training

| | | | | | |
|---|---|---|---|---|---|
| GPT-4 One Shot | 0.81 | 0.72 | 0.87 | 0.80 | 0.81 |
| GPT-4 RAG Zero Shot | 0.85 | 0.66 | 0.90 | 0.86 | 0.85 |
| GPT-3.5 Turbo One Shot | 0.47 | 0.52 | 0.69 | 0.54 | 0.47 |
| LLama2 13B One Shot | 0.28 | 0.05 | 0.22 | 0.13 | 0.28 |

Stage (3): Post Training Downstream Finetuning

| | | | | | |
|---|---|---|---|---|---|
| Fine Tuned GPT-3.5 Turbo | 0.90 | 0.84 | 0.90 | 0.82 | 0.90 |
| Fine Tuned LLama2 13B + | 0.91 | 0.76 | 0.92 | 0.72 | 0.91 |
| Post Processing | | | | | |
| Fine Tuned Mistral | 0.94 | 0.85 | 0.95 | 0.90 | 0.94 |
| 7B + Post Processing | | | | | |

Thus, the present disclosure presents a comprehensive survey and revolution for LLM sequential customization from foundation model, prompt engineering, RAG, and model fine-tuning for an oil and gas domain application, specifically to identify the drilling risks from drilling remarks in the DDRs. For practical applications, the best performing model (e.g., fine-tuned Mistral 7B) may be implemented to a field with 180 DDRs from 24 wells. Nearly 7% of hidden events were uncovered from 85% drilling remarks that were not captured with NPT events.

Manual review takes about a month at 6 reports per day, while automation only takes 0.5 seconds per report, totaling 1.5 to 2 hours for the hidden events discovery. With these, it may be seen that the LLM offers opportunities for augmenting risk management in well construction. Using locally hosted models on cost-efficient infrastructure ensures data privacy and residency while supporting the well construction risk management process. This may facilitate further research and inspire breakthroughs in the application of LLMs within the oil and gas industry. The demonstrated improvements in risk identification and workflow efficiency underscore the potential of LLMs to transform operational practices in this field.

Table 16 illustrates a one-shot prompt: drilling risk examples and explanations.

TABLE 16

| Drilling remarks | Drilling risk | Risk explanation |
|---|---|---|
| Performed test on tools. | tool or equipment | Several reasons can speed up |
| Lost communication to | failure | machinery failure, such as bad |
| tools. | | operating conditions, lack of routine |
| | | maintenance, improper usage, and |
| | | poor storage conditions. |
| Attempted to come up | tight hole or overPull | The text mentions “took overpull”. |
| with string and took | | |
| overpull. | | |
| CONTINUED TO | stuck pipe | Stuck pipe is caused by: internal cake |
| WORK PIPE FREE | | pressure decreases at the point where |
| | | the drillpipe contacts the filter cake, |
| | | causing the pipe to be held against the |
| | | wall by differential pressure. |
| Observed gain in | pit gain or loss | The text contains “observed gain”. |
| triptank indicating | | |
| swabbing when pulling | | |
| single. | | |
| CHECKED OUT | No Risk | No Risk means there is no possibility |
| CABLE - OK. | | of damage or loss of assets, no |
| | | damage, no negative consequences |
| REPAIRED UPPER | miscellaneous rig | The text mentions a rig problem of |
| RACKING ARM. | equipment | RACKING ARM . |
| LOST 1.5 M3 MUD | loss circulation | The text records the lost things. |
| WHILE WASHING | | |
| DOWN FROM CASING | | |
| WINDOW. | | |
| to avoid reaming pass | Hard Stringers | This text contains some drilling |
| the hard stringer. | | parameters and also mentions “hard |
| | | string”. |
| Remove gumbo stuck on | Gumbo | This text mentions “gumbo” and make |
| pipe. | | an observation with it |
| NOTE: EXCESSIVE | excessive drag | The text contains “excessive drag”. |
| DRAG FROM 2930 | | |
| EXCESSIVE CUTTINGS | excessive casing wear | The text contains “excessive cuttings |
| AND CAVINGS AT SHAKERS. | or cuttings | and cavings” |
| Drilled cutting and | Caving | This text contains “caving” and |
| caving | | “cavings”. And we cannot categorize |
| | | caving under ‘Hard Stringers’. |
| WORKED ON SHEAR | blow out preventer | The text mentions import keywords: |
| RAM. | events | “HEAR RAM” |

Table 17 illustrates a few-shot prompt: added drilling risk examples.

TABLE 17

| Drilling remarks | Drilling risk |
|---|---|
| Broke and racked back stand. | tool or equipment |
| | failure |
| Up weight 181 MT/down weight 141 MT. | tight hole or overPull |
| Observe with gumbo | Gumbo |
| Recording Drilling parameters such as | Hard Stringers |
| Flowrate, 1 pm SPP, RPM Torque . . . , etc | |
| Rig repair | miscellaneous rig |
| | equipment |

### Prediction Distribution

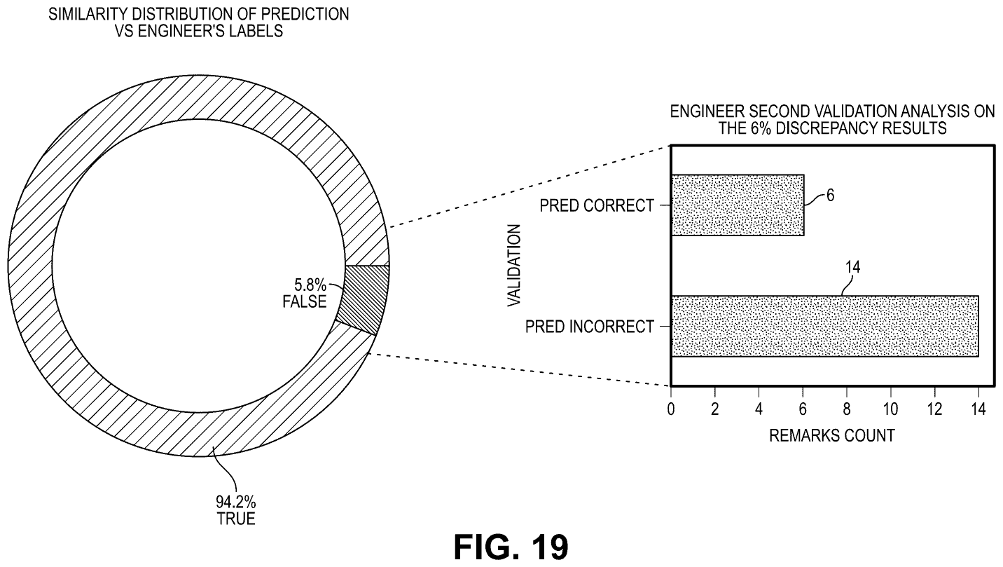

FIG. 19 statistics of a prediction distribution after a second engineering validation, according to an embodiment. Out of 342 validation remarks, 94% of the engineering labels matched with the model prediction. The remaining 6% discrepancy results went through a second round of validation from the drilling engineer. Six of these were validated with correct model prediction, and 14 were incorrect. The total accuracy achieved after the second validation is near 96%.

Table 18 illustrates six validation examples mis-labeled by manual labelling.

TABLE 18

| Start | End | End | | Drilling | GenAI | hidden | Engineer |
|---|---|---|---|---|---|---|---|
| time | time | Depth mMD | Remark | Risk | Prediction | NPT_flag | Validation |
| 16:30 | 17:30 | 1030 | HYDRAULIC POWER UNIT FOR CASING | tool or | miscellaneous | FALSE | Pred |
| | | | TONG OVERHEATED. | equipment | rig equipment | | Correct |
| | | | | failure | | | |
| 17:15 | 17:45 | 0 | Laid out MS seal, retrieval tool and jet sub. Reset | No Risk | tool or | FALSE | Pred |
| | | | running tool. Observed hydraulic leak from PRS. | | equipment | | Correct |
| | | | | | failure | | |
| 23:00 | 0:00 | 100 | P/U and M/U 12 ¼″″ BHA including HWDP as per | No Risk | tool or | FALSE | Pred |
| | | | Baker DD instructions. \nChanged out one HWDP, | | equipment | | Correct |
| | | | damaged box observed. | | failure | | |
| 13:00 | 17:45 | 3387 | RB 1 std from 3510 m to 3478 m. No obstruction | No Risk | tight hole | FALSE | Pred |
| | | | encountered. \n\n Worked 1 std from 3478 m to 3437 | | or overPull | | Correct |
| | | | m, 2200 1 pm/201 bar, 150 rpm/12-15 kNm. \n\nRB | | | | |
| | | | and reamed 1 std from 3437 m to 3397 m. Observed | | | | |
| | | | tight spots at 3428 m and 3423 m. Reamed through | | | | |
| | | | tigh spots with reduced flow of 1500 1 pm due to | | | | |
| | | | packing off. Staged up parameteres to 2200 1 pm/200 | | | | |
| | | | bar while working through tight spots. \n\nRB 1 | | | | |
| | | | std and circulated btms up whilst rotation and | | | | |
| | | | reciprocating pipe from 3397 m to 3357 m, 2200 1 pm/ | | | | |
| | | | 198 bar, 100 rpm/12-14 kNm. | | | | |
| 17:00 | 19:45 | 5201 | Cont. circulating 1x B/U at 3596 1 pm (950 gpm), | Caving | No Risk | FALSE | Pred |
| | | | 8067 kPa (1170 psi) while reciprocating stand. | | | | Correct |
| | | | Wellsite Geologist confirmed B/U samples as 80% | | | | |
| | | | claystone and 20% claystone. Section TD confirmed at | | | | |
| | | | 921 m by Ops Geologist. Ops Geologist | | | | |
| | | | Summary: ========================================= - | | | | |
| | | | Formation Top F1.0 (858.00 m MDBDF/−823.00 mTVDSS) | | | | |
| | | | indicated 8.4 mTVDSS shallower than prognosis. - At | | | | |
| | | | 921.00 m MDBDF, well trajectory is 0.25 m Below | | | | |
| | | | and 0.03 m right of the planed trajectory with a | | | | |
| | | | distance of 0.25 m centre to centre. - Maximum | | | | |
| | | | Total gas peak observed was 1.54% TG at 776 m | | | | |
| | | | MDBDF lag depth. - The back-ground gas ranged 0.50- | | | | |
| | | | 1.00% TG, no drilled gas peaks were recorded. No | | | | |
| | | | HC Show was seen in the cuttings. - No observed | | | | |
| | | | any caving during drilling. - No downhole mud | | | | |
| | | | losses reported. - Drilled in hydrostatic pore | | | | |
| | | | pressure regime, no event gas or abnormal flow | | | | |
| | | | observed. - Mud Weight was maintained at 10.8-10.9 | | | | |
| | | | kPa/m while drilling with LWD-ECD: 11.60-12.07 | | | | |
| | | | kPa/m. | | | | |
| 18:00 | 19:45 | 6541 | Continue POOH 5″ DP and 5″ stinger to surface. The | Caving | tool or | FALSE | Pred |
| | | | observation of the stinger is as follows: All 4 | | equipment | | Correct |
| | | | fins are broken off slightly above the weld | | failure | | |
| | | | point. -- Bottom 1 meter of B/N plugged with | | | | |
| | | | fines “Sticky” clay, and next meter have large | | | | |
| | | | shale “cavings” inside circulation ports. The | | | | |
| | | | largest dimension of the cutting is about 5 × 2 cm. | | | | |

### Additional Details

As discussed, the method described herein identifies drilling risks based on retrieval-enhanced generation (RAG) and domain knowledge enhancement using a large language model (LLM). It includes the following innovations

The method includes a unified parsing module for multi-format documents. This module can receive unstructured and/or structured content, including html, images, PDF, scanned documents, csv, excel, etc., and automatically select the corresponding parsing strategy according to the content type, including but not limited to OCR recognition, table extraction, data cleaning, etc.

The method builds a drilling-related knowledge database based on additional supporting documents. More particularly, the method may build a RAG knowledge database for the drilling field to fill the knowledge gap of general LLM in professional fields. Additional file support documents may include a dictionary of technical abbreviations in the drilling field, professional term explanations, and/or historical cases as RAG model input to fill the gap in the knowledge of the large model in the drilling field. In an example, this may include the 4800 SLB Oil & Gas Glossary, 3400 SPE Glossary, and 22000 DDR Remarks.

The method may also implement a multi-granularity text segmentation strategy that improves the quality of knowledge fragments. In an example, CharacterTextSplitter, NLTK Splitter, and RecursiveTextSplitter (using set of separators: “\n\n”, “\n”, “ ”) and other text segmentation strategies may be used, respectively. Different chunk sizes and overlap parameters (e.g., (1000,100), (512,20), (256,20)) may be combined to adapt to the diversity of drilling documents and improve retrieval accuracy and generation quality.

The method may use knowledge vectorization based on multiple embedding models. For example, OpenAI and HuggingFace embedding may be used to vectorize knowledge fragments, which enhances the semantic expression ability and cross-model compatibility of the knowledge base.

A Facebook AI Similarity Search (FAISS) and/or Chroma vector database may be used to balance retrieval efficiency and data management capabilities. The method may also use supporting dynamic updates and expansion of domain knowledge integration mechanism. For example, the knowledge database supports dynamic update mechanism, allowing new drilling cases, technical documents, and term explanations to ensure that the knowledge base is kept up to date and enhance the practicality and adaptability of the system

The method may define user prompt templates to improve the semantic clarity and executability of input instructions. More particularly, the method may propose a structured user prompt input format, including Objective, Step, Example, Explanation, and Expected Output fields, to enhance the language model's ability to understand user intent and avoid ambiguity caused by free input. When generating the final prompt, the method may automatically merge the user input with the relevant fragments in the RAG search results to improve the professionalism and accuracy of the model generation results.

The method was verified in the drilling risk identification task and found that the configuration scheme based on GPT-4, OpenAI Embedding, RecursiveTextSplitter (e.g., chunk size=512, overlap=20) and One-Shot Prompt performed best, with better recognition accuracy and response efficiency than other combinations.

The method includes multi-model fine-tuning. More particularly, the method supports fine-tuning of multiple models such as GPT series models (e.g., GPT-4, GPT-3.5 Turbo) and local models (e.g., Llama2 13B, Mistral 7B), and compares performance based on the division of training sets and validation sets to identify the optimal model configuration. Introducing in-house post-processing improves recognition accuracy. The method was verified in the drilling risk identification task and found that the combination of Mistral 7B model, fine-tuning training and in-house post-processing performed best with an accuracy of 94%, with better recognition accuracy and response efficiency than other models, solving the performance bottleneck of local models in professional tasks.

### Exemplary Method

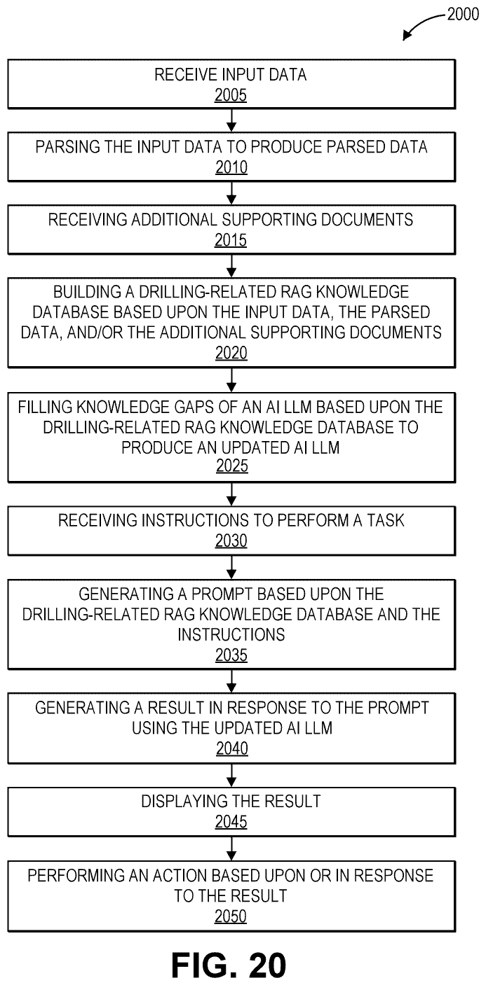

FIG. 20 illustrates a flowchart of a method 2000 for generating drilling operation insights using a GenAI LLM, according to an embodiment. More particularly, the method 2000 may be used to monitor and/or control a drilling operation. An illustrative order of the method 2000 is provided below; however, one or more portions of the method 2000 may be performed in a different order, simultaneously, repeated, or omitted. At least a portion of the method 2000 may be performed by a computing system.

The method 2000 may include receiving input data, as at 2005. The input data may be received from a web application. The input data may be or include multi-format documents including hypertext markup language (HTML), images, scanned documents, portable document format (PDF), character separated values (CSV) format, table format, or a combination thereof. The input data may include one or more daily drilling reports (DDRs). The one or more DDRs may include structured and/or unstructured data. The one or more DDRs may be received from different vendors and/or different drilling operators.

The method 2000 may also include parsing the input data to produce parsed data, as at 2010. The input data may be parsed based upon a content type of the input data including object character recognition (OCR), table extraction, data cleaning, or a combination thereof. The parsed data may include structured results in a comma-separated values (CSV) format.

The method 2000 may also include receiving additional supporting documents, as at 2015. The additional supporting documents may include a dictionary of technical abbreviations, professional term explanations, historical cases related to historical drilling operations, or a combination thereof. The input data and the additional supporting documents form a knowledge base that includes a plurality of knowledge fragments.

The method 2000 may also include building a drilling-related retrieval augmented generation (RAG) knowledge database based upon the input data, the parsed data, and/or the additional supporting documents, as at 2020. Building the drilling-related RAG knowledge database may implement a multi-granularity text segmentation strategy that improves a quality of the knowledge fragments. Building the drilling-related RAG knowledge database may combine different chunk sizes and overlap parameters to adapt to a diversity of the input data and the additional supporting documents and to improve a retrieval accuracy and a generation quality. The chunk sizes may be 1000, 512, and/or 256, and the overlap parameters may be 100 or 20. In examples, the chunk sizes and overlap parameters may be (1000, 100), (512, 20), and/or (256, 20). Building the drilling-related RAG knowledge database may implement knowledge vectorization based upon multiple embedding models to vectorize the knowledge fragments, which enhances a semantic expression ability and cross-model capability of the knowledge base. Building the drilling-related RAG knowledge database may use an AI similarity search and/or a vector database to balance retrieval efficiency and data management capabilities.

The method 2000 may also include filling knowledge gaps of an artificial intelligence (AI) large language model (LLM) based upon the drilling-related RAG knowledge database to produce an updated AI LLM, as at 2025.

The method 2000 may also include receiving instructions to perform a task, as at 2030. The instructions may be received with a domain prompt template. The domain prompt template may include one or more fields including objective, step, example, explanation, expected output, or a combination thereof. The task may be related to the drilling operation. In an example, the drilling operation may be a directional drilling campaign conducted in a deepwater offshore oil field, aiming to reach a potential hydrocarbon reservoir located approximately 3,200 meters below the seabed. This operation utilizes a semi-submersible drilling rig equipped with a top drive system, blowout preventer (BOP), mud circulation system, and logging-while-drilling (LWD) tools. In an example, the task may be summarizing the operation process.

The method 2000 may also include generating a prompt based upon the drilling-related RAG knowledge database and the instructions, as at 2035.

The method 2000 may also include generating a result in response to the prompt using the updated AI LLM, as at 2040. The result may identify drilling risks associated with the task. In an example, the drilling risk(s) may include tool or equipment failure, tight hole or over-pull, stuck pipe, loss circulation, or no risk.

The method 2000 may also include displaying the result, as at 2045.

The method 2000 may also include performing an action based upon or in response to the result, as at 2050. In an embodiment, the action may be or include performing a domain workflow or other data analysis. In another embodiment, the action may be or include generating and/or transmitting a signal (e.g., using a computing system) that recommends, instructs, or causes a physical action to occur at an oil and gas wellsite or facility. In yet another embodiment, the action may also or instead include performing the physical action at the wellsite or facility. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

### Exemplary Computing System

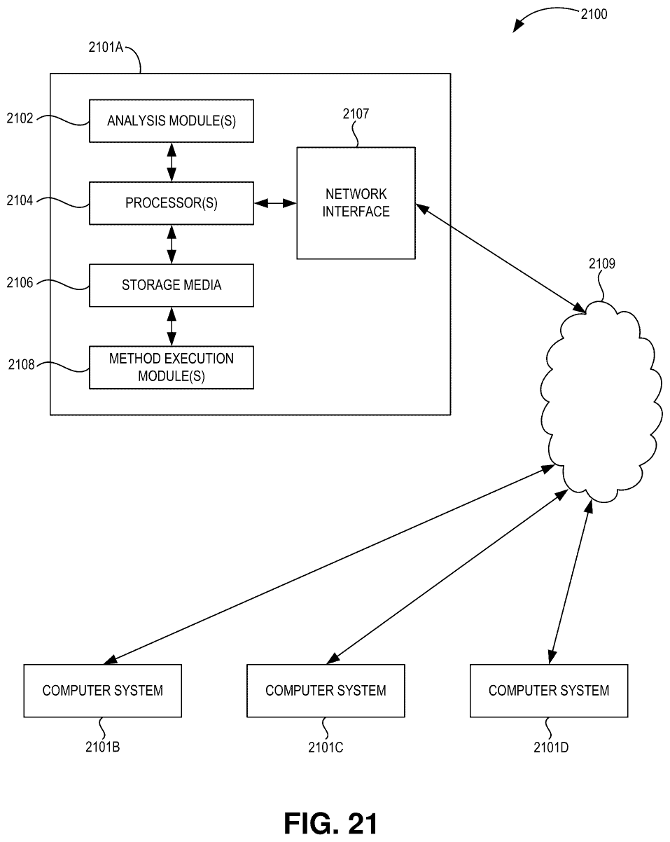

In some embodiments, the methods of the present disclosure may be executed by a computing system. FIG. 21 illustrates an example of such a computing system 2100, in accordance with some embodiments. The computing system 2100 may include a computer or computer system 2101A, which may be an individual computer system 2101A or an arrangement of distributed computer systems. The computer system 2101A includes one or more analysis modules 2102 that are configured to perform various tasks according to some embodiments, such as one or more methods disclosed herein. To perform these various tasks, the analysis module 2102 executes independently, or in coordination with, one or more processors 2104, which is (or are) connected to one or more storage media 2106. The processor(s) 2104 is (or are) also connected to a network interface 2107 to allow the computer system 2101A to communicate over a data network 2109 with one or more additional computer systems and/or computing systems, such as 2101B, 2101C, and/or 2101D (note that computer systems 2101B, 2101C and/or 2101D may or may not share the same architecture as computer system 2101A, and may be located in different physical locations, e.g., computer systems 2101A and 2101B may be located in a processing facility, while in communication with one or more computer systems such as 2101C and/or 2101D that are located in one or more data centers, and/or located in varying countries on different continents).

A processor may include a microprocessor, microcontroller, processor module or subsystem, programmable integrated circuit, programmable gate array, or another control or computing device.

The storage media 2106 may be implemented as one or more computer-readable or machine-readable storage media. Note that while in the example embodiment of FIG. 21 storage media 2106 is depicted as within computer system 2101A, in some embodiments, storage media 2106 may be distributed within and/or across multiple internal and/or external enclosures of computing system 2101A and/or additional computing systems. Storage media 2106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 2100 contains one or more method execution module(s) 2108. In the example of computing system 2100, computer system 2101A includes the method execution module 2108. In some embodiments, a single method execution module may be used to perform some aspects of one or more embodiments of the methods disclosed herein. In other embodiments, a plurality of method execution modules may be used to perform some aspects of methods herein.

It should be appreciated that computing system 2100 is merely one example of a computing system, and that computing system 2100 may have more or fewer components than shown, may combine additional components not depicted in the example embodiment of FIG. 21, and/or computing system 2100 may have a different configuration or arrangement of the components depicted in FIG. 21. The various components shown in FIG. 21 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 2100, FIG. 21), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for monitoring a drilling operation, the method comprising:
receiving input data and additional supporting documents;
building a drilling-related retrieval augmented generation (RAG) knowledge database based upon the input data and the additional supporting documents;
filling knowledge gaps of an artificial intelligence (AI) large language model (LLM) based upon the drilling-related RAG knowledge database to produce an updated AI LLM;
receiving instructions to perform a task that is related to the drilling operation; and
generating a result in response to the instructions using the updated AI LLM.

2. The method of claim 1, wherein the input data is received from a web application.

3. The method of claim 1, wherein the input data comprises multi-format documents including hypertext markup language (HTML), images, scanned documents, portable document format (PDF), character separated values (CSV) format, and table format.

4. The method of claim 1, wherein the input data comprises one or more daily drilling reports (DDRs) including unstructured data, and wherein the one or more DDRs are received from different vendors and different drilling operators.

5. The method of claim 1, further comprising parsing the input data to produce parsed data, wherein the drilling-related RAG knowledge database is also built based upon the parsed data.

6. The method of claim 5, wherein the input data is parsed based upon a content type of the input data including object character recognition (OCR), table extraction, and data cleaning, and wherein the parsed data comprises structured results in a comma-separated values (CSV) format.

7. The method of claim 1, wherein the additional supporting documents comprise a dictionary of technical abbreviations, professional term explanations, and historical cases related to historical drilling operations.

8. The method of claim 1, further comprising generating a prompt by updating the instructions based upon the drilling-related RAG knowledge database, wherein the result is generated in response to the prompt.

9. The method of claim 1, further comprising displaying the result, which identifies drilling risks associated with performing the task.

10. The method of claim 1, further comprising performing an action in response to the result, wherein the result identifies drilling risks associated with performing the task.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data and additional supporting documents;
building a drilling-related retrieval augmented generation (RAG) knowledge database based upon the input data and the additional supporting documents;
filling knowledge gaps of an artificial intelligence (AI) large language model (LLM) based upon the drilling-related RAG knowledge database to produce an updated AI LLM;
receiving instructions to perform a task; and
generating a result in response to the instructions using the updated AI LLM.

12. The computing system of claim 11, wherein the input data and the additional supporting documents form a knowledge base that includes a plurality of knowledge fragments, and wherein building the drilling-related RAG knowledge database implements a multi-granularity text segmentation strategy that improves a quality of the knowledge fragments.

13. The computing system of claim 12, wherein building the drilling-related RAG knowledge database implements knowledge vectorization based upon multiple embedding models to vectorize the knowledge fragments, which enhances a semantic expression ability and cross-model capability of the knowledge base.

14. The computing system of claim 11, wherein building the drilling-related RAG knowledge database combines different chunk sizes and overlap parameters to adapt to a diversity of the input data and the additional supporting documents and to improve a retrieval accuracy and a generation quality, and wherein the chunk sizes and overlap parameters are (1000, 100), (512, 20), and/or (256, 20).

15. The computing system of claim 11, wherein building the drilling-related RAG knowledge database uses an AI similarity search and a vector database to balance retrieval efficiency and data management capabilities.

16. A non-transitory computer-readable medium storing instructions that, when executed by one or more processors of a computing system, cause the computing system to perform operations, the operations comprising:
receiving input data and additional supporting documents;
building a drilling-related retrieval augmented generation (RAG) knowledge database based upon the input data and the additional supporting documents;
filling knowledge gaps of an artificial intelligence (AI) large language model (LLM) based upon the drilling-related RAG knowledge database to produce an updated AI LLM;
receiving instructions to perform a task; and
generating a result in response to the instructions using the updated AI LLM.

17. The non-transitory computer-readable medium of claim 16, wherein the input data is received from a web application, wherein the input data comprises multi-format documents including hypertext markup language (HTML), images, scanned documents, portable document format (PDF), character separated values (CSV) format, table format, or a combination thereof, wherein the input data comprises one or more daily drilling reports (DDRs), wherein the one or more DDRs comprise unstructured data, and wherein the one or more DDRs are received from different vendors and/or different drilling operators.

18. The non-transitory computer-readable medium of claim 17, wherein the additional supporting documents comprise a dictionary of technical abbreviations, professional term explanations, historical cases related to historical drilling operations, or a combination thereof, and wherein the input data and the additional supporting documents form a knowledge base that includes a plurality of knowledge fragments.

19. The non-transitory computer-readable medium of claim 18, wherein building the drilling-related RAG knowledge database implements a multi-granularity text segmentation strategy that improves a quality of the knowledge fragments, wherein building the drilling-related RAG knowledge database combines different chunk sizes and overlap parameters to adapt to a diversity of the input data and the additional supporting documents and to improve a retrieval accuracy and a generation quality, wherein the chunk sizes and overlap parameters are (1000, 100), (512, 20), and/or (256, 20), wherein building the drilling-related RAG knowledge database implements knowledge vectorization based upon multiple embedding models to vectorize the knowledge fragments, which enhances a semantic expression ability and cross-model capability of the knowledge base, and wherein building the drilling-related RAG knowledge database uses an AI similarity search and a vector database to balance retrieval efficiency and data management capabilities.

20. The non-transitory computer-readable medium of claim 19, wherein the operations comprise:
generating a prompt by updating the instructions based upon the drilling-related RAG knowledge database, wherein the result is generated in response to the prompt;
displaying the result; and
performing an action based upon or in response to the result, wherein the action comprises generating and/or transmitting a signal that recommends, instructs, or causes a physical action to occur at an oil and gas wellsite or facility.
